(19) United States
(12) Patent Application Publication
(10) Pub. No.: US 2025/0233647 A1
(43) Pub. Date: Jul. 17, 2025

(54) METHOD AND APPARATUS FOR SIGNAL TRANSMISSION IN A WIRELESS COMMUNICATION SYSTEM

(71) Applicant: SAMSUNG ELECTRONICS CO., LTD., Suwon-si, Gyeonggi-do (KR)

(72) Inventors: Zhe CHEN, Beijing (CN); Feifei SUN, Beijing (CN); Jingxing FU, Beijing (CN); Bin YU, Beijing (CN)

(21) Appl. No.: 18/853,672

(22) PCT Filed: Mar. 31, 2023
(86) PCT No.: PCT/KR2023/004396

§ 371 Date: Oct. 2, 2024

(30) Foreign Application Priority Data
Apr. 2, 2022 (CN) 202210351784.7

(51) Int. Cl. H04B 7/155; H04W 72/0446; H04W 72/23

(52) U.S. Cl. CPC H04B 7/15542; H04W 72/0446; H04W 72/23

(57) ABSTRACT

The disclosure relates to a 5G or 6G communication system for supporting a higher data transmission rate. Specifically, the disclosure related to method and apparatus for receiving and transmitting information. A method performed by a network controlled repeater (NCR) in a wireless communication system. The method includes receiving, by an NCR mobile terminal (NCR-MT) from a base station, control information. Further, the method includes determining a first resource based on the control information. Further, the method includes receiving, by the NCR-MT from the base station, a downlink signal on the first resource. Further, the method includes transmitting, by an NCR-amplifier to a user equipment (UE), the downlink signal on a second resource which is delayed in time domain from the first resource.

### TECHNICAL FIELD

The present disclosure relates to a wireless communication, and more specifically, the present disclosure relates to a method and apparatus for signal transmission in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to a method and device for receiving and transmitting information/signal in a wireless communication system, which can improve the performance of a repeater.

### Solution to Problem

In an embodiment, a method performed by a repeater in a wireless communication system is provided, the method comprising: receiving control information from a base station; determining first time domain resources based on the control information; and transmitting and/or receiving signal on the first time domain resource.

In an example, the repeater includes a mobile terminal for transmitting signal to the base station and/or receiving signal from the base station and/or processing signal; and an amplifier for receiving and/or transmitting radio frequency signal.

In an example, the first time domain resources are determined based on at least one of the followings: a slot format and/or time unit indicated by the control information; a predefined time unit; delay of the amplifier; uplink and/or downlink guard period(s) of the amplifier; direction switching time of the amplifier; second time domain resources for the mobile terminal to transmit and/or receive signal; timing advance corresponding to the mobile terminal; switching time between the amplifier and the mobile terminal.

In an example, the first time domain resources are determined based on at least one of the followings: the difference between the starting time of the first time domain resources and the starting time of the second time domain resources; the difference between the ending time of the first time domain resources and the ending time of the second time domain resources.

In an example, the difference between the starting time of the first time domain resources and the starting time of the second time domain resources is related to at least one of N*T, T₁ or T_{TA}; and/or the difference between the ending time of the first time domain resources and the ending time of the second time domain resources is related to at least one of N*T, T₁ or T_{TA}, wherein T₁ indicates the delay between transmission and reception of the amplifier, T_{TA} indicates the timing advance corresponding to the mobile terminal, and N is a natural number, and T is symbol length.

In an embodiment, a method performed by a repeater in a wireless communication system is provided, the method comprising: receiving control information from a base station; determining first time domain resources based on the control information; and not transmitting and/or not receiving signal on the first time domain resource.

In an example, the repeater includes a mobile terminal for generating signal and transmitting signal to the base station and/or receiving signal from the base station and/or processing signal; and an amplifier for receiving and/or transmitting radio frequency signal.

In an example, the first time domain resource are determined based on at least one of the followings: a slot format and/or time unit indicated by the control information; a predefined time unit; direction switching time of the amplifier; second time domain resources for the mobile terminal to transmit and/or receive signal; timing advance corresponding to the mobile terminal; switching time between the amplifier and the mobile terminal.

In an example, the first time domain resources are determined based on at least one of the followings: the difference between the starting time of the first time domain resources and the starting time of the second time domain resources; the difference between the ending time of the first time domain resources and the ending time of the second time domain resources.

In an example, the difference between the starting time of the first time domain resources and the starting time of the second time domain resources is related to at least one of N*T, T₁ or T_{TA}; and/or the difference between the ending time of the first time domain resources and the ending time of the second time domain resources is related to at least one of N*T, T₁ or T_{TA}, wherein T₁ indicates the delay between transmission and reception of the amplifier, T_{TA} indicates the timing advance corresponding to the mobile terminal, and N is a natural number, and T is symbol length.

In an embodiment, a method performed by a base station in a wireless communication system is provided, the method comprising: transmitting control information to a repeater; wherein the control information is used to determine first time domain resources, and the first time domain resources are used for transmitting and/or receiving signal.

In an embodiment, a method performed by a base station in a wireless communication system is provided, the method comprising: transmitting control information to a repeater; wherein the control information is used to determine first time domain resources, and the first time domain resources are not used for transmitting and/or receiving signal.

In an embodiment, a repeater in a wireless communication system is provided, comprising: a mobile terminal configured to receive control information from a base station, and determining first time domain resources based on the control information; and an amplifier configured to transmit and/or receive signal and/or not transmit and/or not receive signal on the first time domain resources.

In an example, the first time domain resources are determined based on at least one of the followings: a slot format and/or time unit indicated by the control information; a predefined time unit; delay of the amplifier; uplink and/or downlink guard period(s) of the amplifier; direction switching time of the amplifier; second time domain resources for the mobile terminal to transmit and/or receive signal; timing advance corresponding to the mobile terminal; switching time between the amplifier and the mobile terminal.

In an example, the first time domain resources are determined based on at least one of the followings: the difference between the starting time of the first time domain resources and the starting time of the second time domain resources; the difference between the ending time of the first time domain resources and the ending time of the second time domain resources.

In an example, the difference between the starting time of the first time domain resources and the starting time of the second time domain resources is related to at least one of N*T, T₁ or T_{TA}; and/or the difference between the ending time of the first time domain resources and the ending time of the second time domain resources is related to at least one of N*T, T₁ or T_{TA}, wherein T₁ indicates the delay between transmission and reception of the amplifier, T_{TA} indicates the timing advance corresponding to the mobile terminal, and N is a natural number, and T is symbol length.

In an embodiment, a base station in a wireless communication system is provided, including a transceiver; and a processor coupled to the transceiver and configured to perform the method performed by the base station according to the embodiments of the present disclosure.

### Advantageous Effects of Invention

The repeater can determine the time for receiving and/or forwarding the RF signal through the synchronization information of the base station. Therefore, the precise boundaries for receiving and/or forwarding of radio frequency signal can be accurately determined, interference to other communication devices can be avoided, and the performance of the communication system can be improved.

### BRIEF DESCRIPTION OF DRAWINGS

The above and other aspects, features and advantages of the present invention will become more apparent from the following detailed description when taken in conjunction with the accompanying drawings.

FIG. 1 illustrates an example of wireless communication network according to various embodiments of the present disclosure;

FIG. 2A illustrates a transmitting path 200 in a wireless communication network according to various embodiments of the present disclosure;

FIG. 2B illustrates a receiving path 250 in a wireless communication network according to various embodiments of the present disclosure;

FIG. 3A illustrates the structures of a user equipment (UE) in a wireless communication network according to various embodiments of the present disclosure;

FIG. 3B illustrates the structures of a base station in a wireless communication network according to various embodiments of the present disclosure;

FIG. 4 illustrates the structure of a 5G wireless communication system including a repeater;

FIG. 5A illustrates the structure of a 5G wireless communication system including a repeater according to an embodiment of the present disclosure;

FIG. 5B illustrates the structure of a 5G wireless communication system including a repeater according to an embodiment of the present disclosure;

FIG. 6A illustrates an example of a repeater transmitting and/or receiving signal according to an embodiment of the present disclosure;

FIG. 6B illustrates an example of a repeater transmitting and/or receiving signal according to an embodiment of the present disclosure;

FIG. 7 illustrates an example of a repeater transmitting and/or receiving signal according to an embodiment of the present disclosure;

FIG. 8A illustrates an example of a repeater transmitting and/or receiving signal according to an embodiment of the present disclosure;

FIG. 8B illustrates an example of a repeater transmitting and/or receiving signal according to an embodiment of the present disclosure;

FIG. 9A illustrates an example of a repeater transmitting and/or receiving signal according to an embodiment of the present disclosure;

FIG. 9B illustrates an example of a repeater transmitting and/or receiving signal according to an embodiment of the present disclosure;

FIG. 10A illustrates an example of a repeater transmitting and/or receiving signal according to an embodiment of the present disclosure;

FIG. 10B illustrates an example of a repeater transmitting and/or receiving signal according to an embodiment of the present disclosure;

FIG. 10C illustrates an example of a repeater transmitting and/or receiving signal according to an embodiment of the present disclosure;

FIG. 11A illustrates an example of a repeater transmitting and/or receiving signal according to an embodiment of the present disclosure;

FIG. 11B illustrates an example of a repeater transmitting and/or receiving signal according to an embodiment of the present disclosure;

FIG. 12A illustrates an example of a repeater transmitting and/or receiving signal according to an embodiment of the present disclosure;

FIG. 12B illustrates an example of a repeater transmitting and/or receiving signal according to an embodiment of the present disclosure;

FIG. 13A illustrates an example of a repeater transmitting and/or receiving signal according to an embodiment of the present disclosure;

FIG. 13B illustrates an example of a repeater transmitting and/or receiving signal according to an embodiment of the present disclosure;

FIG. 14A illustrates an example of a repeater transmitting and/or receiving signal according to an embodiment of the present disclosure;

FIG. 14B illustrates an example of a repeater transmitting and/or receiving signal according to an embodiment of the present disclosure;

FIG. 15 illustrates an example of a repeater transmitting and/or receiving signal according to an embodiment of the present disclosure;

FIG. 16 illustrates an example of a repeater transmitting and/or receiving signal according to an embodiment of the present disclosure;

FIG. 17A illustrates an example of a repeater transmitting and/or receiving signal according to an embodiment of the present disclosure;

FIG. 17B illustrates an example of a repeater transmitting and/or receiving signal according to an embodiment of the present disclosure;

FIG. 18 illustrates an example of a repeater transmitting and/or receiving signal according to an embodiment of the present disclosure;

FIG. 19 illustrates an example of a repeater transmitting and/or receiving signal according to an embodiment of the present disclosure;

FIG. 20 illustrates an example of a repeater not transmitting and/or not receiving signal according to an embodiment of the present disclosure;

FIG. 21 illustrates an example of a repeater not transmitting and/or not receiving signal according to an embodiment of the present disclosure;

FIG. 22A illustrates an example of a repeater not transmitting and/or not receiving signal according to an embodiment of the present disclosure;

FIG. 22B illustrates an example of a repeater not transmitting and/or not receiving signal according to an embodiment of the present disclosure;

FIG. 23A illustrates an example of a repeater not transmitting and/or not receiving signal according to an embodiment of the present disclosure;

FIG. 23B illustrates an example of a repeater not transmitting and/or not receiving signal according to an embodiment of the present disclosure;

FIG. 24A illustrates an example of a repeater not transmitting and/or not receiving signal according to an embodiment of the present disclosure;

FIG. 24B illustrates an example of a repeater not transmitting and/or not receiving signal according to an embodiment of the present disclosure;

FIG. 25 illustrates an example of a repeater not transmitting and/or not receiving signal according to an embodiment of the present disclosure;

FIG. 26A illustrates an example of a repeater not transmitting and/or not receiving signal according to an embodiment of the present disclosure;

FIG. 26B illustrates an example of a repeater not transmitting and/or not receiving signal according to an embodiment of the present disclosure;

FIG. 27 illustrates an example of a repeater not transmitting and/or not receiving signal according to an embodiment of the present disclosure;

FIG. 28 illustrates an example of a repeater not transmitting and/or not receiving signal according to an embodiment of the present disclosure;

FIG. 29 illustrates a flowchart of a method performed by a repeater according to an embodiment of the present disclosure;

FIG. 30 illustrates a flowchart of a method performed by a repeater according to an embodiment of the present disclosure;

FIG. 31 illustrates a flowchart of a method performed by a base station according to an embodiment of the present disclosure;

FIG. 32 illustrates a block diagram of a repeater according to an embodiment of the present disclosure;

FIG. 33 illustrates a block diagram of a base station (BS) according to an embodiment of the present disclosure; and

FIG. 34 illustrates a block diagram of a terminal (or a user equipment (UE)) according to an embodiment of the present disclosure.

### MODE FOR THE INVENTION

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called downlink, and transmission from a UE to a base station is called uplink.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

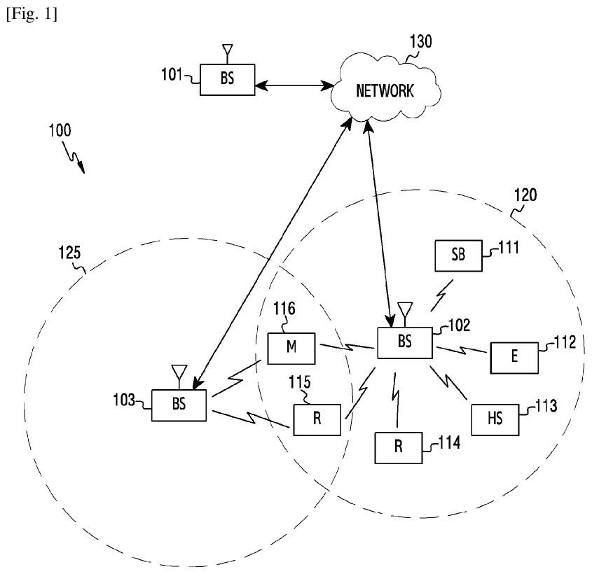

FIG. 1 through FIG. 34, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

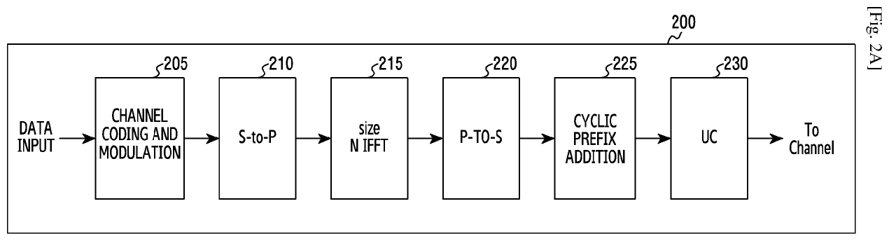

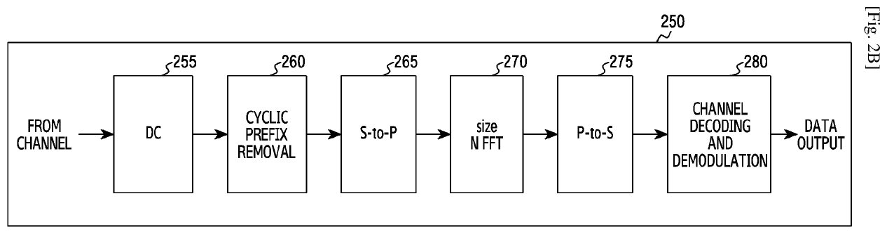

FIGS. 2A and 2B illustrate example wireless transmission and reception paths according to the present disclosure. FIG. 2A illustrates a transmitting path 200 in a wireless communication network according to various embodiments of the present disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

FIG. 2B illustrates a receiving path 250 in a wireless communication network according to various embodiments of the present disclosure.

In the following description, the reception path 250 can be described as being implemented in a UE, such as UE 116. However, it should be understood that the reception path 250 can be implemented in a gNB. In some embodiments, the reception path 250 is configured to support codebook designs and structures for systems with 2D antenna arrays as described in embodiments of the present disclosure.

The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signal. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2a and 2b can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

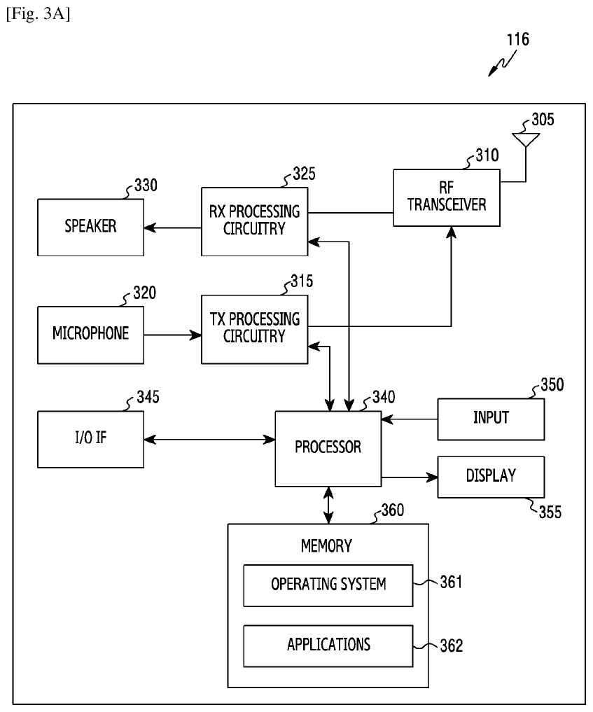

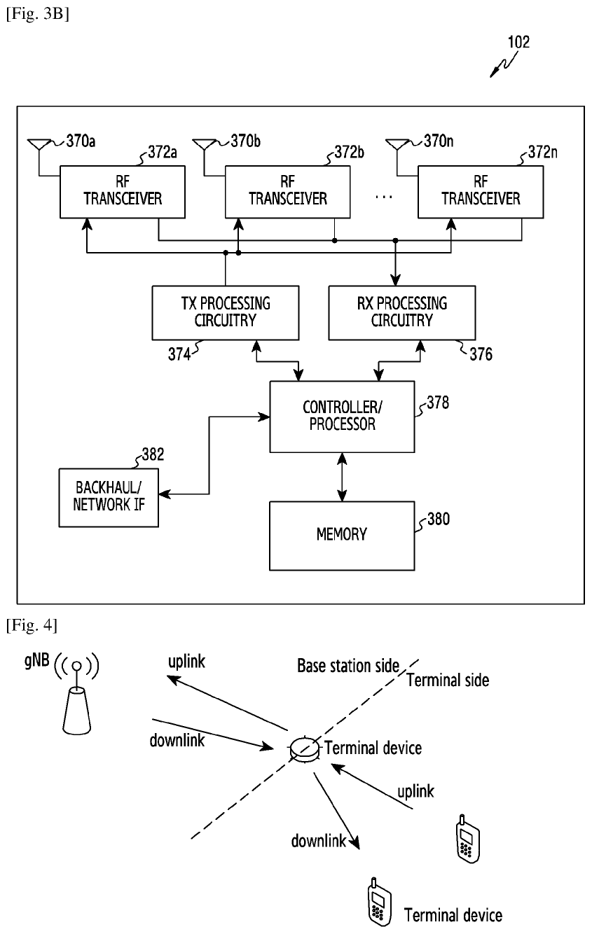

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signal and the transmission of backward channel signal through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signal received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signal and the transmission of backward channel signal through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3b. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Hereinafter, embodiments of the present disclosure will be described in detail with reference to the accompanying drawings. It should be noted that in the drawings, the same or similar elements are denoted by the same or similar reference numerals as much as possible. In addition, detailed descriptions of known functions or configurations that may obscure the subject matter of the present disclosure will be omitted.

When describing the embodiments of the present disclosure, the description related to the technical contents known in the art and not directly related to the present disclosure will be omitted. Such omission of unnecessary descriptions is to prevent obscuring the main idea of this disclosure and to convey the main idea more clearly.

For the same reason, some elements may be enlarged, omitted or shown schematically in the drawings. In addition, the size of each component does not fully reflect the actual size. In the drawings, the same or corresponding elements have the same reference numerals.

The advantages and features of the present disclosure and the way to implement them will become clear by referring to the embodiments described in detail below in conjunction with the accompanying drawings. However, the present disclosure is not limited to the embodiments set forth below, but can be implemented in various forms. The following examples are provided only to fully disclose this disclosure and inform those skilled in the art of the scope of this disclosure, and this disclosure is only limited by the scope of the appended claims. Throughout the specification, the same or similar reference numerals refer to the same or similar elements.

In order to enhance the coverage of the 5G wireless communication system, one implementation is to set up a repeater at the edge of the cell (or the area with poor coverage of the cell signal). Generally, the repeater is usually consist of two sides, a base station side and a terminal side.

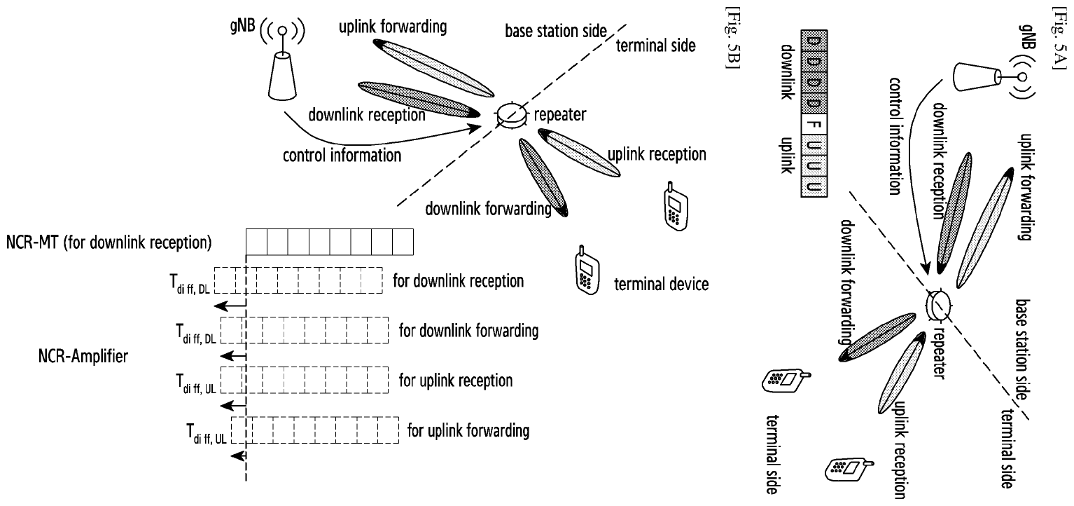

FIG. 4 illustrates the structure of a 5G wireless communication system including a repeater. As shown in FIG. 4, for the downlink of a base station, the repeater receives radio frequency (RF) signal from the base station at the base station side. These RF signal pass through the built-in amplifier in the repeater, and the amplified signal is transmitted to the terminal device at the terminal side of the repeater. For the uplink of the base station, the repeater receives radio frequency (RF) signal from the terminal device at the terminal side. These RF signal pass through the built-in amplifier in the repeater, and the amplified signal is transmitted to the base station at the base station side of the repeater.

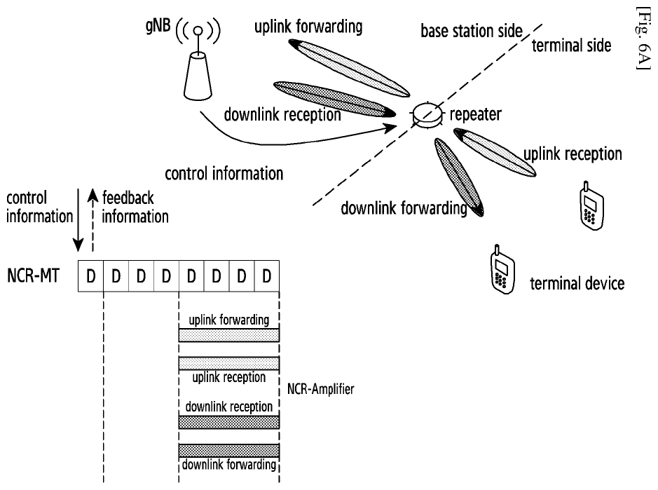

Generally, the existing repeater cannot be controlled by the base station. That is, the reception/transmission timing of the repeater for the existing repeater can be only adjusted manually, which may cause the uplink and downlink forwarding timing of the repeater to be misaligned with that of the base station or the terminal device, which is not beneficial to the deployment of the repeater in a TDD system and causes unnecessary interference. In addition, the existing repeater cannot be controlled to be turned on and off through the indication of the base station. This may cause the repeater to turn on at inappropriate time, causing unnecessary interference. To solve the above problems, this patent proposes a number of methods, as shown in FIG. 5A, to enable the repeater to receive the indication information from the network, so as to flexibly adjust the uplink/downlink forwarding timing of the repeater (or flexibly control the on or off of the repeater), thereby improving the performance of the wireless communication system.

In this disclosure, a repeater has two functions: one is to receive and forward radio frequency signal, and the other is to receive signal (e.g., control information) from a base station, and/or transmit signal to the base station, and/or process signal, wherein processing signal includes at least generating signal and/or processing the received signal, etc.

For example, the module that receives and forwards a radio frequency signal can be called network-controlled repeater RF amplifier (NCR-Amplifier) or repeater forward. Taking NCR-Amplifier as an example, there is no limitation to the naming of the module that receives and forwards a radio frequency signal in this disclosure.

For another example, the module used to receive signal from the base station and/or transmit signal to the base station and/or process signal is called a network-controlled repeater mobile terminal (NCR-MT) or the module is called a repeater mobile terminal. Taking NCR-MT as an example, there is no limitation to the naming of the module used to receive signal from the base station and/or transmit signal to the base station and/or process signal in this disclosure.

In this disclosure, a repeater can represent either an NCR-MT or an NCR-Amplifier, or the combination of both. In addition, the NCR-MT can also be equivalently understood as a UE, that is, it can be equivalently understood as a terminal device (UE). It can be understood that the NCR-MT in this disclosure can exchange various signaling, channels, data and control information with the base station. Of course, the repeater can also implement, by one entity, the functions of the module for receiving and forwarding a radio frequency signal and the module for receiving signal from a base station and/or transmitting signal to a base station and/or processing signal. Therefore, there is no limitation to the structure of the repeater in this disclosure.

In this disclosure, in order to avoid ambiguity, corresponding names are defined here for the transmitting and receiving behaviors of a repeater.

FIG. 5A illustrates the structure of a 5G wireless communication system including a repeater according to an embodiment of the present disclosure. As shown in FIG. 5A, for a repeater (especially an NCR-Amplifier), the radio frequency signal reception for downlink (or the radio frequency signal reception at the base station side) is called downlink reception; the radio frequency signal transmission for downlink (or the radio frequency signal transmission at the terminal side; or the radio frequency signal forwarding to the terminal device) is called downlink forwarding; the radio frequency signal reception for uplink (or the radio frequency signal reception at the terminal side) is called uplink reception; the radio frequency signal transmission for the uplink (or the radio frequency signal transmission at the base station side; or the radio frequency signal forwarding to the base station) is called uplink forwarding.

The present disclosure will be explained in detail by the description of specific embodiments with reference to the accompanying drawings.

### Embodiment 1 (Reference Downlink Grid, the Repeater Turns On/Transmits Signal)

In a TDD frequency band (for example, unpaired frequency spectrum), a repeater establishes connection with a base station through an NCR-MT, wherein, the time unit (granularity) used for the NCR-MT to receive downlink signal can be determined by the following ways (in addition, the time unit used for at least one of downlink reception, downlink forwarding, uplink reception and uplink forwarding of an NCR-Amplifier can also be determined by the following ways), wherein, these time units may be at least one of a frame, a subframe, a slot, a sub-slot, a symbol, etc, wherein, the sub-carrier spacing (SCS) corresponding to the slot, the sub-slot and the symbol can be determined according to at least one of the following ways:
reference subcarrier spacing. For example, the reference subcarrier spacing indication (referenceSubcarrierSpacing) in TDD configuration information (tdd-UL-DL-ConfigurationCommon). Furthermore, the TDD configuration information is used for the PCell of the NCR-MT.
subcarrier spacing of an SSB; furthermore, this SSB is related to the NCR-MT. For example, the subcarrier spacing of the SSB corresponding to the latest PRACH transmission by the NCR-MT; for another example, the base station indicates the TCI state of CORESET #0 via MAC-CE signaling, and the SSB corresponds to (is associated with) the TCI state.
the subcarrier spacing is predefined, for example, 15 kHz, 30 kHz, 60 kHz, 120 kHz and 240 kHz.
the subcarrier spacing is related to the frequency range; furthermore, the subcarrier spacing for different frequency ranges can be configured (defined) respectively, where these frequency ranges include FR1 and FR2 (FR2-1 and FR2-2, refer to the existing specification for the meaning). For example, the subcarrier spacing is 15 kHz for FR1; the subcarrier spacing is 60 kHz for FR2.
the sub-carrier spacing corresponding to CORESET #0 of the NCR-MT.
the subcarrier spacing corresponding to the initial BWP of the NCR-MT. For example, subCarrierSpacingCommon in the MIB.

In Embodiment 1, the reference downlink grid can be understood as the reference downlink time domain unit (e.g., a downlink frame, a downlink subframe, a downlink slot, a downlink symbol) (e.g., of the NCR-MT).

In Embodiment 1, the reference downlink grid can also be understood as a time domain unit (e.g., a frame, a subframe, a slot, a symbol) (e.g., used by the NCR-MT for downlink reception).

In Embodiment 1, the reference downlink grid can be understood as a grid in which the timing advance (TA) of an uplink time domain unit (e.g., an uplink slot and an uplink symbol) is 0.

Optionally, in Embodiment 1, the reference downlink grid can also be understood as a grid in which the TA of a flexible time domain unit (flexible symbol) is 0.

In a FDD frequency band (for example, paired frequency spectrum), the repeater establishes a connection with the base station through the NCR-MT, wherein, the time unit for the NCR-MT to receive downlink signal can be determined in the following ways (in addition, the time unit for at least one of downlink reception, downlink forwarding, uplink reception and uplink forwarding of the NCR-Amplifier can also be determined in the following ways), wherein, the time unit can be a frame, a sub-frame, a slot, a sub-slot and a symbol, wherein, the sub-carrier spacing (SCS) corresponding to the slot, sub-slot and symbol can be determined according to at least one of the following ways:
subcarrier spacing of an SSB; furthermore, this SSB is related to the NCR-MT. For example, the subcarrier spacing of the SSB corresponding to the latest PRACH transmission by the NCR-MT; for another example, the base station indicates the TCI state of CORESET #0 via MAC-CE signaling, and the SSB corresponds to the TCI state.
the subcarrier spacing is predefined, for example, 15 kHz, 30 kHz, and 60 kHz.
sub-carrier spacing corresponding to CORESET #0 of the NCR-MT.
subcarrier spacing corresponding to the initial DL BWP of the NCR-MT. For example, subCarrierSpacingCommon in the MIB.

FIG. 5B illustrates the structure of a 5G wireless communication system including a repeater according to an embodiment of the present disclosure. As shown in FIG. 5B, the time difference between the reception timing of the NCR-MT and the downlink reception of the NCR-Amplifier is called T_{diff,DL}; the time difference between the reception timing of the NCR-MT and the downlink forwarding of the NCR-Amplifier is also called T′_{diff,DL}; the time difference between the reception timing of the NCR-MT and the uplink forwarding of the NCR-Amplifier is also called T_{diff,UL}; the time difference between the reception timing of the NCR-MT and the uplink forwarding of the NCR-Amplifier is also called T′_{diff,UL}. In addition, unless otherwise specified, the above time differences are equal to each other and are collectively referred as T_{diff}.

The value of T_{diff} (T_{diff,DL}, T′_{diff,DL}, T_{diff,UL}, T′_{diff,UL}) can be predefined, or it can be

reported to the base station through a UE capability report. In addition, the T_{diff} (T_{diff,DL}, T′_{diff,DL}, T_{diff,UL}, T′_{diff,UL}) may also be indicated by the base station (for example, indicated through RRC, MAC CE or DCI). The unit corresponding to T_{diff} (T_{diff,DL}, T′_{diff,DL}, T_{diff,UL}, T′_{diff,UL}) can be an absolute time, for example, millisecond, microsecond, sample point (Tc, refer to 38.211 for specific definition); the unit corresponding to T_{diff} (T_{diff,DL}, T′_{diff,DL}, T_{diff,UL}, T′_{diff,UL}) can also be a slot, a symbol. In addition, T_{diff} can also be related to T₁ and T_{TA}, and further, T_{diff} can be a function of T₁ and T_{TA}. For the definitions of T₁ and T_{TA}, please refer to the subsequent description of the specification.

In an example, the difference between the starting time of the corresponding time unit of the NCR-MT and the starting time of the NCR-Amplifier signal reception and/or transmission (or the corresponding time unit of the NCR-Amplifier) is T_{diff}+N*T, where N is a natural number and T is the length of the time unit.

In another example, the difference between the ending time of the corresponding time unit of the NCR-MT and the ending time of the NCR-Amplifier signal reception and/or transmission (or the corresponding time unit of the NCR-Amplifier) is T_{diff}+N*T, where N is a natural number and T is the length of the time unit.

### Example 1 (FDD Scenario, Repeater Off to On)

In the following example, in a FDD spectrum, how a repeater is turned on after receiving control information is explained. Being in the FDD spectrum can be understood as the repeater NCR-Amplifier operating in the FDD spectrum. In this example, the time unit used by the NCR-MT for downlink reception is a slot. The subcarrier spacing corresponding to the slot is the subcarrier spacing corresponding to the initial DL BWP of the NCR-MT (provided by MIB in subCarrierSpacingCommon).

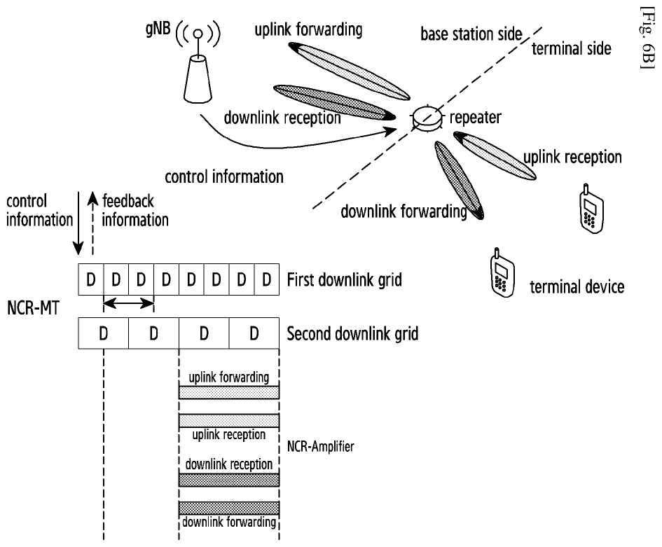

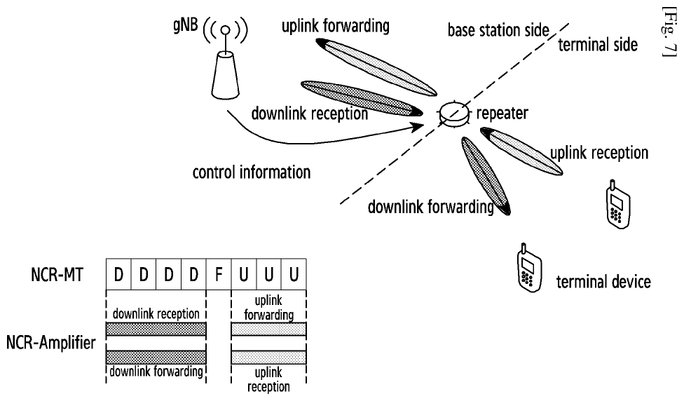

FIG. 6A illustrates an example of a repeater transmitting and/or receiving signal according to an embodiment of the present disclosure. As shown in FIG. 6A, the repeater establishes a connection with the base station through the NCR-MT, and obtains the subcarrier spacing corresponding to the downlink slot through system information (for example, subCarrierSpacingCommon in MIB), and determines the downlink slot boundaries. Specifically, the Figure includes eight slots, namely, slot #1 to slot #8 in sequence. At first, the repeater (the NCR-Amplifier) was turned off. The NCR-MT of the repeater receives the control information from the base station in the first slot (or transmits the feedback corresponding to the control information of the base station in the first slot). Specifically, the control information is used to turn on (or activate) the repeater (the NCR-Amplifier). After receiving the control information, more specifically, after a period of time (e.g., 3 ms, three slots) following the reception of the control information (or the transmission the feedback information for the control information), the repeater (the NCR-Amplifier) starts to perform at least one of the following actions: downlink reception; downward forwarding; uplink reception; uplink forwarding. The above example can also be understood that the time unit corresponding to the downlink reception, downlink forwarding, uplink reception and/or uplink forwarding of the NCR-Amplifier is a slot, where the subcarrier spacing corresponding to the slot is the subcarrier spacing corresponding to the initial DL BWP of the NCR-MT (provided by MIB in subCarrierSpacingCommon). In addition, take T_{diff}=0 as an example in this example. That is, the reception/transmission grid of the NCR-Amplifier and the downlink reception grid of the NCR-MT are aligned (for example, the boundaries of subframes are aligned).

FIG. 6B illustrates an example of a repeater transmitting and/or receiving signal according to an embodiment of the present disclosure. As shown in FIG. 6B, the (UE-specific) subcarrier spacing of the control information received by the NCR-MT is a first subcarrier spacing (for example, 30 kHZ); a time unit of the repeater NCR-Amplifier, for example is a slot, the subcarrier spacing of which (for example, 15 kHz) is determined by the subcarrier spacing of the initial DL BWP of the NCR-MT. In addition, take T_{diff}=0 as an example in this example. In this case, in the first NCR-Amplifier slot after a period of time (for example, 2 ms, two NCR-MT slots following the slot related to receiving the control information) following the NCR-MT slot, the repeater (NCR-Amplifier) starts to perform at least one of the following actions:

downlink reception; downward forwarding; uplink reception; uplink forwarding.

It should be noted that the above method for turning on the NCR-Amplifier is also applicable in TDD frequency band. That is, the method provided by this example can be used in combination with the methods provided by the following examples.

### Example 2 (TDD Scenario)

The following example illustrates how a repeater transmits and/or receives signal according to the slot format information. In this example, take the time unit used by the NCR-MT for downlink reception being a symbol as an example, wherein, the subcarrier spacing corresponding to the symbol is the reference subcarrier spacing (provided by referenceSubcarrierSpacing in tdd-UL-DL-ConfigurationCommon).

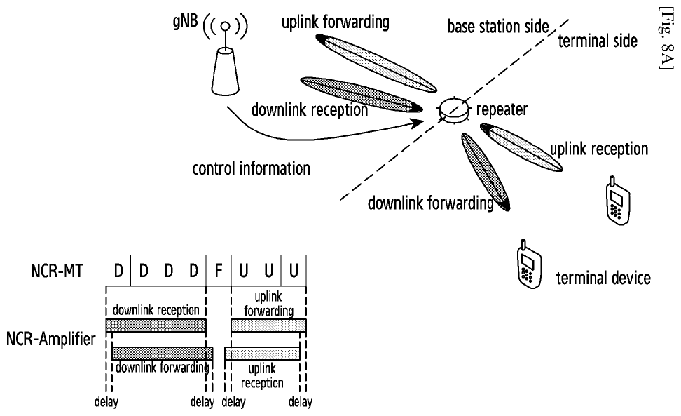

FIG. 7 illustrates an example of a repeater transmitting and/or receiving signal according to an embodiment of the present disclosure. As shown in FIG. 7, according to the above description, the repeater establishes a connection with the base station through the NCR-MT to obtain TDD configuration information. Here, the TDD configuration information is used to indicate which symbols are uplink, downlink or flexible. Specifically, the Figure includes 8 symbols (refer to the downlink reception slots/grid of the NCR-MT), which are symbol #1 to symbol #8 in sequence. According to the slot format information (for example, the slot format information is determined according to at least one of UE-specific information, cell-common information and group-common information; herein, take the slot format information being determined according to cell-common information as an example), the first four symbols are downlink (D), the fifth symbol is flexible (F), and the last three symbols are uplink (U). For the repeater, downlink reception and/or downlink forwarding are performed on the time domain resources related to downlink symbols; and/or uplink reception and/or uplink forwarding are performed on the time domain resources related to uplink symbols.

In an example, the difference between the symbol starting time of the NCR-MT and the starting time of the NCR-Amplifier signal reception and/or transmission is N*T, where N is a natural number and T is the symbol length.

In another example, the difference between the symbol ending time of the NCR-MT and the ending time of the NCR-Amplifier signal reception and/or transmission is N*T, where N is a natural number and T is the symbol length.

More specifically:
The starting time of downlink reception of the NCR-Amplifier is the same as the starting time of the first symbol of consecutive downlink symbols (for example, the first downlink symbol); or, the NCR-Amplifier starts downlink reception at the starting of the first symbol of the consecutive downlink symbols (for example, the first downlink symbol); or, the NCR-Amplifier starts downlink reception no later than the starting of the first symbol of the consecutive downlink symbols (for example, the first downlink symbol).
The ending time of downlink reception of the NCR-Amplifier is the same as the ending time of the last symbol of consecutive downlink symbols (for example, the fourth downlink symbol); or, the NCR-Amplifier stops the downlink reception at the ending of the last symbol of consecutive downlink symbols (for example, the fourth downlink symbol); or, the NCR-Amplifier stops downlink reception no earlier than the ending of the last symbol of consecutive downlink symbols (for example, the fourth downlink symbol).
The starting time of downlink forwarding of the NCR-Amplifier is the same as the starting time of the first symbol of consecutive downlink symbols (for example, the first downlink symbol); or, the NCR-Amplifier starts downlink forwarding at the starting of the first symbol of consecutive downlink symbols (for example, the first downlink symbol); or, the NCR-Amplifier starts downlink forwarding no later than the starting of the first symbol of consecutive downlink symbols (for example, the first downlink symbol).
The ending time of downlink forwarding of the NCR-Amplifier is the same as the ending time of the last symbol of consecutive downlink symbols (for example, the fourth downlink symbol); or, the NCR-Amplifier stops downlink forwarding at the ending of the last symbol of the consecutive downlink symbols (for example, the fourth downlink symbol); or, the NCR-Amplifier stops downlink forwarding no earlier than the ending of the last symbol of consecutive downlink symbols (for example, the fourth downlink symbol).
The starting time of uplink reception of the NCR-Amplifier is the same as the starting time of the first symbol of the consecutive uplink symbols (for example, the first uplink symbol); or, the NCR-Amplifier starts uplink reception at the starting of the first symbol of consecutive uplink symbols (for example, the first uplink symbol); or, the NCR-Amplifier starts uplink reception no later than the starting of the first symbol of the consecutive uplink symbols (for example, the first uplink symbol).
The ending time of uplink reception of the NCR-Amplifier is the same as the ending time of the last symbol of the consecutive uplink symbols (for example, the third uplink symbol); or, the NCR-Amplifier stops uplink reception at the ending of the last symbol of the consecutive uplink symbols (for example, the third uplink symbol); or, the NCR-Amplifier stops the uplink reception no earlier than the ending of the last symbol of consecutive uplink symbols (for example, the third uplink symbol).
The starting time of uplink forwarding of the NCR-Amplifier is the same as the starting time of the first symbol of consecutive uplink symbols (for example, the first uplink symbol); or, the NCR-Amplifier starts uplink forwarding at the starting of the first symbol of consecutive uplink symbols (for example, the first uplink symbol); or, the NCR-Amplifier starts uplink forwarding no later than the starting of the first symbol of the consecutive uplink symbols (for example, the first uplink symbol).
The ending time of uplink forwarding of the NCR-Amplifier is the same as the ending time of the last symbol of consecutive uplink symbols (for example, the third uplink symbol); or, the NCR-Amplifier stops uplink forwarding at the ending of the last symbol of the consecutive uplink symbols (for example, the third uplink symbol); or, the NCR-Amplifier stops the uplink forwarding no earlier than the ending of the last symbol of consecutive uplink symbols (for example, the third uplink symbol).

In addition, it should be noted that in the above example, it can be understood that the time unit corresponding to the downlink reception, downlink forwarding, uplink reception and/or uplink forwarding of the NCR-Amplifier is a symbol, wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the downlink symbols (for example, consecutive downlink symbols) are located, and the NCR-Amplifier of the repeater performs downlink reception and/or forwarding in the NCR-Amplifier symbols overlapping with these time domain resources. In addition, the NCR-MT of the repeater determines the time domain resources where the uplink symbols (for example, consecutive uplink symbols) are located (without considering TA), and the NCR-Amplifier of the repeater performs uplink reception and/or forwarding in the NCR-Amplifier symbols overlapping with these time domain resources.

### Example 3 (Delay)

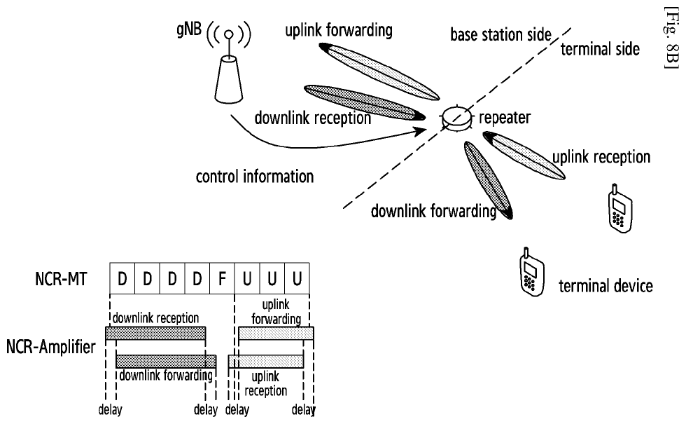

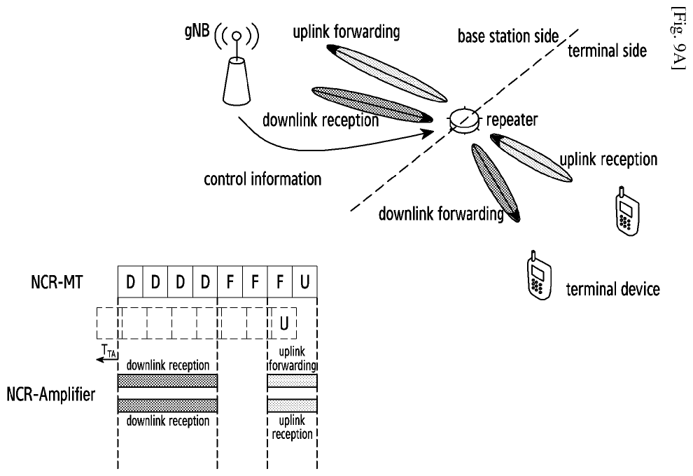

The reception and/or forwarding of the repeater is related to the delay of the NCR-Amplifier. FIG. 8A illustrates an example of a repeater transmitting and/or receiving signal according to an embodiment of the present disclosure. Example 3 is similar to Example 2, except that there is a delay between the receiving and forwarding of the repeater.

As shown in FIG. 8A, there is a delay T₁ between downlink reception and downlink forwarding of the repeater; there is also a delay T₂ between uplink reception and uplink forwarding. Here, take T₁ being equal to T₂ as an example, which are collectively referred as T₁. This delay can be a processing delay, that is, a hardware processing time. The value of T₁ can be predefined or reported to the base station by the UE capability report. In addition, the delay may also be indicated by the base station (for example, indicated by RRC, MAC CE or DCI). For example, the delay can also be configured by the base station according to the corresponding UE capability report. In addition, the unit corresponding to T₁ can be an absolute time, for example, millisecond, microsecond, sample point (T_{c}); the unit corresponding to T₁ can also be a slot, a symbol.

In an example, the difference between the symbol starting time of the NCR-MT and the starting time of the NCR-Amplifier signal reception and/or transmission is N*T, where N is a natural number and T is the symbol length.

In another example, the difference between the symbol ending time of the NCR-MT and the ending time of the NCR-Amplifier signal reception and/or transmission is N*T, where N is a natural number and T is the symbol length.

In another example, the difference between the symbol starting time of the NCR-MT and the starting time of the NCR-Amplifier signal reception and/or transmission is T₁ +N*T, where N is a natural number and T is the symbol length.

In another example, the difference between the symbol ending time of the NCR-MT and the ending time of the NCR-Amplifier signal reception and/or transmission is T₁ +N*T, where N is a natural number and T is the symbol length.

More specifically:
The difference between the starting time of downlink forwarding of the NCR-Amplifier and the starting time of the first symbol of consecutive downlink symbols (for example, the first downlink symbol) is the delay T₁; or, the NCR-Amplifier starts downlink forwarding after T₁ time following the starting of the first symbol of consecutive downlink symbols (for example, the first downlink symbol); or, the NCR-Amplifier starts downlink forwarding no later than a time after T₁ time following the starting of the first symbol of consecutive downlink symbols (for example, the first downlink symbol).
The difference between the ending time of downlink forwarding of the NCR-Amplifier and the ending time of the last symbol of consecutive downlink symbols (for example, the fourth downlink symbol) is the delay T₁; or, the NCR-Amplifier stops the downlink forwarding after T₁ time following the ending of the last symbol of the consecutive downlink symbols (for example, the fourth downlink symbol); or, the NCR-Amplifier stops the downlink forwarding no earlier than a time after T₁ time following the ending of the last symbol of consecutive downlink symbols (for example, the fourth downlink symbol).
The difference between the starting time of uplink reception of the NCR-Amplifier and the starting time of the first symbol of consecutive uplink symbols (for example, the first uplink symbol) is the delay T₁; or, the NCR-Amplifier starts uplink reception before T₁ time preceding the starting of the first symbol of consecutive uplink symbols (for example, the first uplink symbol); or, the NCR-Amplifier starts the uplink reception no later than a time before T₁ time preceding the starting of the first symbol of the consecutive uplink symbol (for example, the first uplink symbol).
The difference between the ending time of uplink reception of the NCR-Amplifier and the ending time of the last symbol of consecutive uplink symbols (for example, the third uplink symbol) is the delay T₁; or, the NCR-Amplifier stops the uplink reception before T₁ time preceding the ending of the last symbol of the consecutive uplink symbols (for example, the third uplink symbol); or, the NCR-Amplifier stops the uplink reception no earlier than a time before T₁ time preceding the ending of the last symbol of the consecutive uplink symbol (for example, the third uplink symbol).

The above example can also be understood that T_{diff,DL}=0; T′_{diff,DL}=−T₁; T_{diff,UL}=T₁; T′_{diff,UL}=0. Wherein, a positive value represents advance and a negative value represents defer.

FIG. 8B illustrates an example of a repeater transmitting and/or receiving signal according to an embodiment of the present disclosure. As shown in FIG. 8B, similar to FIG. 8A above, the delay T₁ of the repeater is evenly distributed over both sides of the symbol boundaries.

In an example, the difference between the symbol starting time of the NCR-MT and the starting time of the NCR-Amplifier signal reception and/or transmission is T₁/2+N*T, where N is a natural number and T is the symbol length.

In another example, the difference between the symbol ending time of the NCR-MT and the ending time of the NCR-Amplifier signal reception and/or transmission is T₁/2+N*T, where N is a natural number and T is the symbol length.

More specifically:
The difference between the starting time of downlink reception of the NCR-Amplifier and the starting time of the first symbol of consecutive downlink symbols (for example, the first downlink symbol) is delay T₁/2; or, the NCR-Amplifier starts downlink reception before T₁/2 time preceding the starting of the first symbol of the consecutive downlink symbols (for example, the first downlink symbol); or, the NCR-Amplifier starts the downlink reception no later than a time before T₁/2 time preceding the starting of the first symbol of consecutive downlink symbols (for example, the first downlink symbol).
The difference between the ending time of downlink reception of the NCR-Amplifier and the ending time of the last symbol of consecutive downlink symbols (for example, the fourth downlink symbol) is the delay T₁/2; or, the NCR-Amplifier stops the downlink reception before T₁/2 time preceding the ending of the last symbol of the consecutive downlink symbols (for example, the fourth downlink symbol); or, the NCR-Amplifier stops the downlink reception no earlier than a time before T₁/2 time preceding the ending of the last symbol of consecutive downlink symbols (for example, the fourth downlink symbol).
The difference between the starting time of downlink forwarding of the NCR-Amplifier and the starting time of the first symbol of consecutive downlink symbols (for example, the first downlink symbol) is the delay T₁/2; or, the NCR-Amplifier starts downlink forwarding after T₁/2 time following the starting of the first symbol of consecutive downlink symbols (for example, the first downlink symbol); or, the NCR-Amplifier starts downlink forwarding no later than a time after T₁/2 time following the starting of the first symbol of consecutive downlink symbols (for example, the first downlink symbol).
The difference between the ending time of downlink forwarding of the NCR-Amplifier and the ending time of the last symbol of consecutive downlink symbols (for example, the fourth downlink symbol) is the delay T₁/2; or, the NCR-Amplifier stops downlink forwarding after T₁/2 time following the ending of the last symbol of the consecutive downlink symbols (for example, the fourth downlink symbol); or, the NCR-Amplifier stops downlink forwarding no earlier than a time after T₁/2 time following the ending of the last symbol of consecutive downlink symbols (for example, the fourth downlink symbol).
The difference between the starting time of uplink reception of the NCR-Amplifier and the starting time of the first symbol of consecutive uplink symbols (for example, the first uplink symbol) is the delay T₁/2; or, the NCR-Amplifier starts the uplink reception before T₁/2 time preceding the starting of the first symbol of the consecutive uplink symbol (for example, the first uplink symbol); or, the NCR-Amplifier starts uplink reception no later than a time before T₁/2 time preceding the starting of the first symbol of the consecutive uplink symbols (for example, the first uplink symbol).
The difference between the ending time of uplink reception of the NCR-Amplifier and the ending time of the last symbol of consecutive uplink symbols (for example, the third uplink symbol) is delay T₁/2; or, the NCR-Amplifier stops the uplink reception before T₁/2 time preceding the ending of the last symbol of the consecutive uplink symbols (for example, the third uplink symbol); or, the NCR-Amplifier stops the uplink reception no earlier than a time before T₁/2 time preceding the ending of the last symbol of the consecutive uplink symbols (for example, the second uplink symbol).
The difference between the starting time of uplink forwarding of the NCR-Amplifier and the starting time of the first symbol of consecutive uplink symbols (for example, the first previous symbol) is the delay T₁/2; or, the NCR-Amplifier starts uplink forwarding after T₁/2 time following the starting of the first symbol of consecutive uplink symbols (for example, the first uplink symbol); or, the NCR-Amplifier starts uplink forwarding no later than a time after T₁/2 time following the starting of the first symbol of consecutive uplink symbols (for example, the first uplink symbol).
The difference between the ending time of uplink forwarding of the NCR-Amplifier and the ending time of the last symbol of consecutive uplink symbols (for example, the third uplink symbol) is the delay T₁/2; or, the NCR-Amplifier stops uplink forwarding after T₁/2 time following the ending of the last symbol of the consecutive uplink symbols (for example, the second uplink symbol); or, the NCR-Amplifier stops the uplink forwarding no earlier than a time after T₁/2 time following the ending of the last symbol of the consecutive uplink symbols (for example, the third uplink symbol).

The above example can also be understood that T_{diff,DL}=T₁/2; T′_{diff,DL}=−T₁/2; T_{diff,UL}=T₁/2; T′_{diff,UL}=−-T₁/2. Wherein, a positive value represents advance and a negative value represents defer.

### Example 4 (TA)

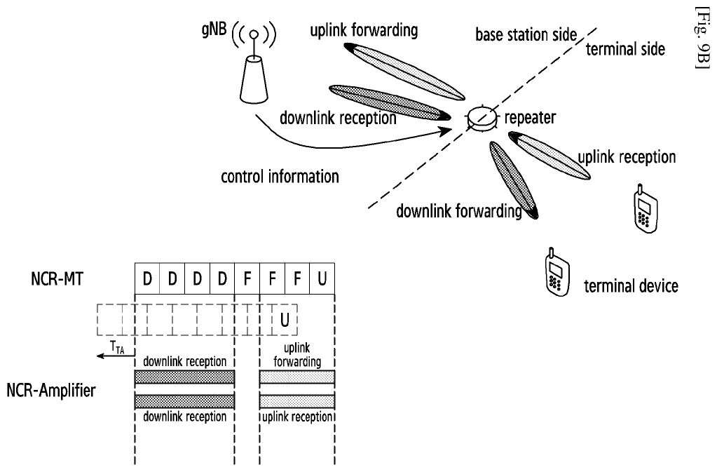

FIG. 9A illustrates an example of a repeater transmitting and/or receiving signal according to an embodiment of the present disclosure. As shown in FIG. 9A, according to the above description, the repeater establishes a connection with the base station through NCR-MT and obtains TDD configuration information. Here, the TDD configuration information is used to indicate which symbols are uplink, downlink or flexible. Specifically, the Figure includes 8 symbols (similar to Example 2, refer to the downlink reception slots/grid of the NCR-MT), which are respectively symbol #1 to symbol #8 in sequence. According to the slot format information (for example, the slot format information is determined according to at least one of UE-specific information, cell-common information and group-common information; herein, take the slot format information being determined according to cell-common information as an example), the first four symbols are downlink (D), the fifth to seventh symbols are flexible (F), and the last symbol is uplink (U). The operation of the repeater (NCR-Amplifier) for downlink reception and/or downlink forwarding on the time domain resources related to downlink symbols is the same as those in Example 2. In addition, the repeater (NCR-Amplifier) performs uplink reception and/or uplink forwarding on the time domain resources related to uplink symbols. At this time, unlike Example 2, the grid referenced by the uplink symbol needs to consider the timing advance corresponding to the NCR-MT. For the method for determining the timing advance, the related art can be referred to. That is, the uplink transmission grid (transmission time) is T_{TA} earlier than the downlink reception grid (reception time). At this time, the uplink symbol determined according to the uplink grid overlaps with the seventh symbol (F) and the eighth symbol (U) corresponding to the downlink grid. Therefore, the repeater (NCR-Amplifier) performs uplink reception and uplink forwarding on these two symbols.

More specifically:
The starting time of uplink reception of the NCR-Amplifier is the same as the starting time of the seventh symbol corresponding to the downlink grid; or, take the downlink slots of the NCR-MT as reference, the NCR-Amplifier starts uplink reception at the starting of the first symbol overlapping with the consecutive uplink symbols; or, take the downlink slots of the NCR-MT as reference, the NCR-Amplifier starts uplink reception no later than the starting of the first symbol overlapping with the consecutive uplink symbols. The consecutive uplink symbols need to consider the TA of the NCR-MT.
The ending time of uplink reception of the NCR-Amplifier is the same as the ending time of the eighth symbol corresponding to the downlink grid; or, take the downlink slots of the NCR-MT as reference, the NCR-Amplifier stops uplink reception at the ending of the last symbol overlapping with the consecutive uplink symbols; or, take the downlink slots of the NCR-MT as reference, the NCR-Amplifier stops uplink reception no later than the ending of the last symbol overlapping with the consecutive uplink symbols. The consecutive uplink symbols need to consider the TA of the NCR-MT.
The starting time of uplink forwarding of the NCR-Amplifier is the same as the starting time of the seventh symbol corresponding to the downlink grid; or, take the downlink slots of the NCR-MT as reference, the NCR-Amplifier starts uplink reception at the starting of the first symbol overlapping with the consecutive uplink symbols; or, take the downlink slots of the NCR-MT as reference, the NCR-Amplifier starts uplink reception no later than the starting of the first symbol overlapping with the consecutive uplink symbols. The consecutive uplink symbols need to consider the TA of the NCR-MT.
The ending time of uplink forwarding of the NCR-Amplifier is the same as the ending time of the eighth symbol corresponding to the downlink grid; or, take the downlink slots of the NCR-MT as reference, the NCR-Amplifier stops uplink reception at the ending of the last symbol overlapping with the consecutive uplink symbols; or, take the downlink slots of the NCR-MT as reference, the NCR-Amplifier stops uplink reception no later than the ending of the last symbol overlapping with the consecutive uplink symbols. The consecutive uplink symbols need to consider the TA of the NCR-MT.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where uplink symbols (for example, consecutive uplink symbols) are located (considering TA), and the NCR-Amplifier of the repeater performs uplink reception and/or forwarding in the NCR-Amplifier symbols overlapping with these time domain resources.

FIG. 9B illustrates an example of a repeater transmitting and/or receiving signal according to an embodiment of the present disclosure. FIG. 9B is a variant of the above example. Compared with the above example, the time of TA is longer. At this time, the repeater (NCR-Amplifier) performs uplink reception and/or uplink forwarding on the sixth symbol to the eighth symbol corresponding to the downlink grid. That is, compared with the previous example, the ending points of uplink forwarding and/or uplink reception are different (take the downlink grid as reference, the ending point is determined by the last symbol of consecutive uplink symbols without considering TA).

More specifically:
The starting time of uplink reception of the NCR-Amplifier is the same as the starting time of the sixth symbol corresponding to the downlink grid; or, take the downlink slots of the NCR-MT as reference, the NCR-Amplifier starts uplink reception at the starting of the first symbol overlapping with the consecutive uplink symbols; or, take the downlink slots of the NCR-MT as reference, the NCR-Amplifier starts uplink reception no later than the starting of the first symbol overlapping with the consecutive uplink symbols. The consecutive uplink symbols need to consider the TA of the NCR-MT.
The ending time of uplink reception of the NCR-Amplifier is the same as the ending time of the eighth symbol corresponding to the downlink grid; or, take the downlink slots of the NCR-MT as reference, the NCR-Amplifier stops uplink reception at the ending of the last symbol of consecutive uplink symbols; or, take the downlink slots of the NCR-MT as reference, the NCR-Amplifier stops uplink reception no later than the ending of the last symbol of consecutive uplink symbols. The consecutive uplink symbols do not need to consider the TA of the NCR-MT (for example, TA is 0).
The starting time of uplink forwarding of the NCR-Amplifier is the same as the starting time of the sixth symbol corresponding to the downlink grid; or, take the downlink slots of the NCR-MT as reference, the NCR-Amplifier starts uplink reception at the starting of the first symbol overlapping with the consecutive uplink symbols; or, take the downlink slots of the NCR-MT as reference, the NCR-Amplifier starts uplink reception no later than the starting of the first symbol overlapping with the consecutive uplink symbols. The consecutive uplink symbols need to consider the TA of the NCR-MT.
The ending time of uplink forwarding of the NCR-Amplifier is the same as the ending time of the eighth symbol corresponding to the downlink grid; or, take the downlink slots of the NCR-MT as reference, the NCR-Amplifier stops uplink reception at the ending of the last symbol of consecutive uplink symbols; or, take the downlink slots of the NCR-MT as reference, the NCR-Amplifier stops uplink reception no later than the ending of the last symbol of consecutive uplink symbols. The consecutive uplink symbols do not need to consider the TA of the NCR-MT (TA is 0).

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines time domain resources which start from the starting of the first of consecutive uplink symbols (considering TA) and end at the ending of the last of consecutive uplink symbols (without considering TA), and the NCR-Amplifier of the repeater performs uplink reception and/or forwarding in the NCR-Amplifier symbol overlapping with the time domain resources.

Another variant is that the NCR-MT of the repeater determines time domain resources which start from the starting of the first of consecutive downlink symbols (considering TA) and end at the ending of the last of consecutive downlink symbols (without considering TA), and the NCR-Amplifier of the repeater performs downlink reception and/or forwarding in the NCR-Amplifier symbol overlapping with the time domain resources.

### Example 5 (UL Guard Period)

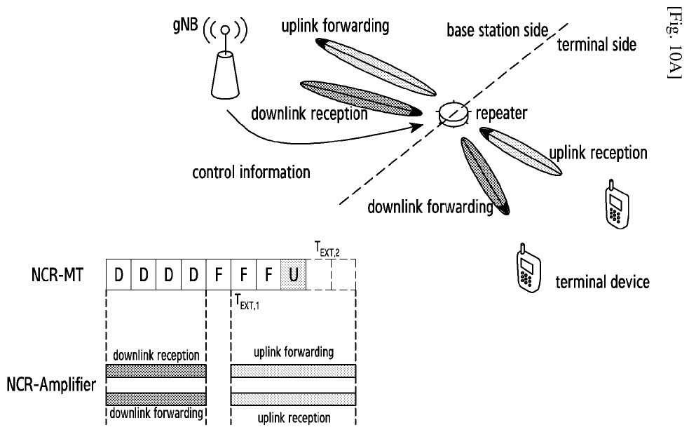

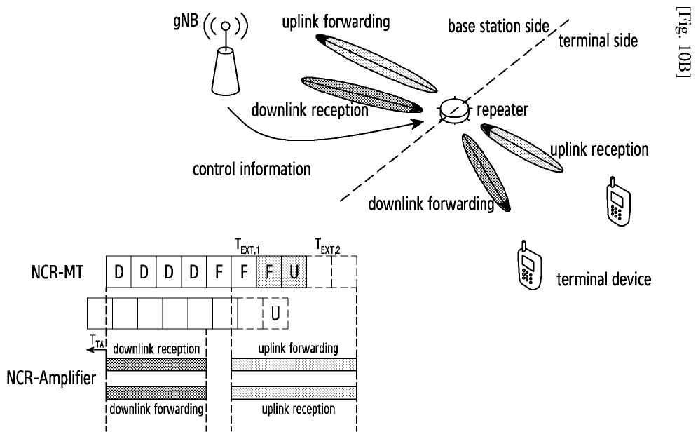

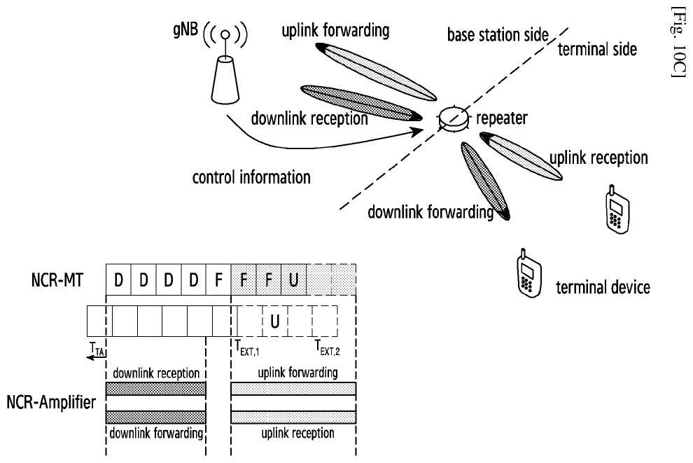

FIG. 10A illustrates an example of a repeater transmitting and/or receiving signal according to an embodiment of the present disclosure. As shown in FIG. 10A, similar to Example 2, the repeater obtains downlink synchronization information and slot format information. Considering that the uplink transmission timing of the terminal devices served by the repeater may be different (out of alignment) from that of the repeater NCR-MT, which may lead that the uplink channels corresponding to these terminal devices cannot be forwarded completely. To solve this problem, based on the above examples, the present disclosure additionally increases the uplink transmission time (T_{ext,1}, T_{ext,2}, respectively, which can be referred as uplink guard periods) before and/or after the uplink transmission time to protect the users served by the repeater. Wherein, the values of T_{ext,1} and T_{ext,2} can be predefined (for example, 1 symbol) or indicated by the base station (for example, indicated by RRC, MAC CE and DCI). In addition, T_{ext,1} and T_{ext,2} can be the same; in addition, T_{ext,1} can be related to the TA of the NCR-MT, for example, the time length corresponding to T_{ext,1} is greater than or equal to T_{TA} corresponding to the NCR-MT; for example, the time length corresponding to T_{ext,1} is longer than T_{TA} corresponding to the NCR-MT. In addition, the unit corresponding to T_{ext,1} (or T_{ext,2}) can be an absolute time, for example, millisecond, microsecond, sample point (T_{c}); the unit corresponding to T_{ext,1} (or T_{ext,2}) can also be a slot, a symbol.

In the following description, take T_{ext,1} being one symbol and T_{ext,2} being two symbols as an example, and T_{ext,1} and T_{ext,2} take downlink grid (time units for downlink reception, downlink slots) corresponding to the NCR-MT as reference. The repeater determines the seventh symbol corresponding to the downlink grid for uplink reception and/or uplink forwarding according to the position of the uplink symbol U corresponding to the NCR-MT. On this basis, the repeater determines the starting position of the uplink forwarding according to T_{ext,1} (that is, the uplink reception and/or forwarding starts from the starting of the seventh symbol of the downlink grid); and the repeater determines the ending position of the uplink forwarding according to the T_{ext,2} (that is, the uplink reception and/or forwarding stops at the ending of the tenth symbol of the downlink grid). Alternatively, the repeater performs uplink reception and/or forwarding in the time units corresponding to the downlink grid overlapping with the time domain resources of T_{ext,1}, uplink symbol U and T_{ext,2}.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where uplink symbols (for example, consecutive uplink symbols) and the corresponding uplink guard periods are located (without considering TA), and the NCR-Amplifier of the repeater performs uplink reception and/or forwarding in the NCR-Amplifier symbols overlapping with these time domain resources.

FIG. 10B illustrates an example of a repeater transmitting and/or receiving signal according to an embodiment of the present disclosure. FIG. 10B is a scheme of TA in conjunction with uplink guard periods. Refer to the above description for the method of determining T_{ext,1} and T_{ext,2}. In the following description, take T_{ext,1} being one symbol and T_{ext,2} being two symbols as an example, and T_{ext,1} and T_{ext,2} take downlink grid (downlink time units, downlink slots) corresponding to the NCR-MT as reference. According to the above description, the repeater determines the time domain resources for uplink reception and/or uplink forwarding according to the TA corresponding to the NCR-MT and the position of uplink symbol U. Specifically, the repeater uses the seventh and eighth symbols corresponding to the symbol U in the downlink grid for uplink reception and uplink forwarding according to the position of the symbol U. On this basis, the repeater determines the starting position of the uplink forwarding according to T_{ext,1} (that is, the uplink reception and/or forwarding starts from the starting of the seventh symbol of the downlink grid); and the repeater determines the ending position of the uplink forwarding according to the T_{ext,2} (that is, the uplink reception and/or forwarding stops at the ending of the tenth symbol of the downlink grid).

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the NCR-Amplifier symbol (considering TA) overlapping with the uplink symbols (for example, consecutive uplink symbols), which is called the first symbol; determines the time domain resources where the first symbol and the uplink guard periods corresponding to the first symbol are located; the NCR-Amplifier of the repeater performs uplink reception and/or forwarding in the NCR-Amplifier symbols overlapping with these time domain resources.

FIG. 10C illustrates an example of a repeater transmitting and/or receiving signal according to an embodiment of the present disclosure. FIG. 10C is a variant of the above example. Take T_{ext,1} being one symbol and T_{ext,2} being two symbols as an example again. T_{ext,1} and T_{ext,2} take the uplink grid (uplink time units, uplink slots) corresponding to the NCR-MT as reference. According to the above description, the repeater determines the seventh to tenth symbols corresponding to the uplink grid for uplink reception and uplink forwarding according to the position of the uplink symbol U corresponding to the NCR-MT and T_{ext,1} and T_{ext,2}. On this basis, the repeater determines the symbols (seventh to tenth symbols corresponding to the downlink grid) for uplink reception which overlap with these symbols (seventh to tenth symbols corresponding to the uplink grid) according to the TA of the NCR-MT. Therefore, the NCR-Amplifier of the repeater performs uplink reception and/or uplink forwarding on the seventh symbol to the tenth symbol corresponding to the downlink grid. For the above Example 5, a variant is that the units of T_{ext,1} and T_{ext,2} are absolute times (for example, microseconds, sample points). This situation can be understood that take the downlink grid of the NCR-MT as reference, the repeater performs uplink transmission on the time domain resources overlapping with (consecutive) uplink symbols and T_{ext,1}, T_{ext,2}.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where uplink symbols (for example, consecutive uplink symbols) and corresponding uplink guard periods (considering TA) are located; the NCR-Amplifier of the repeater performs uplink reception and/or forwarding in the NCR-Amplifier symbols overlapping with these time domain resources.

It should be noted that the method involving the uplink guard periods in Example 5 is also applicable to the method involving the downlink guard periods. That is, the method provided by Example 5 can be applied in a similar way to the case where there are downlink guard periods. In addition, the “uplink guard periods” in this disclosure can also be called “uplink extension time”; and “downlink guard periods” can also be called “downlink extension time”.

### Example 6 (DL/UL Direction Switching)

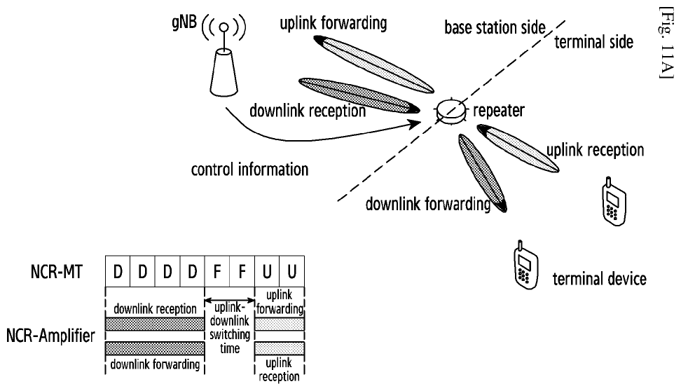

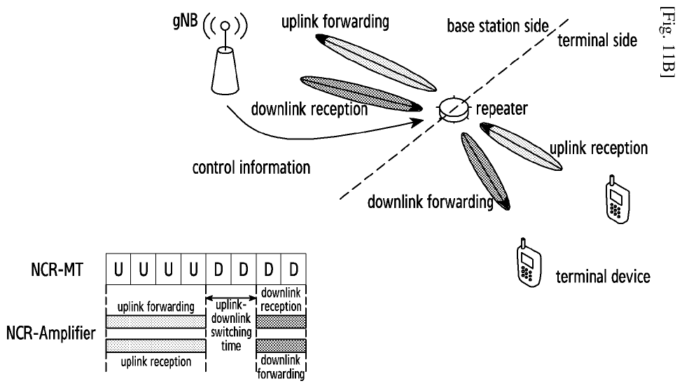

FIG. 11A illustrates an example of a repeater transmitting and/or receiving signal according to an embodiment of the present disclosure. Referring to the scenario of Example 2, the repeater needs a certain time for uplink and downlink switching due to hardware limitations. Specifically, the NCR-Amplifier needs a certain time T_{DL-UL} to perform uplink-downlink switching (downlink-to-uplink switching). The value of T_{DL-UL} can be predefined (for example, 1 symbol, 1 ms); the value of T_{DL-UL} can also be reported to the base station based on the (terminal) capability report; or, the value of T_{DL-UL} may be one configured by the base station for the repeater among a plurality of values based on the (terminal) capability report. In addition, the unit corresponding to T_{DL-UL} can be an absolute time, for example, millisecond, microsecond, sample point (T_{c}); the unit corresponding to T_{DL-UL} can also be a slot, a symbol. In Example 6 of FIG. 11A, T_{DL-UL} is two symbols, and the subcarrier spacing corresponding to the symbols is the reference subcarrier spacing (provided by referenceSubcarrierSpacing in tdd-UL-DL-ConfigurationCommon).

In this case, during T_{DL-UL} symbols after the ending of the consecutive downlink symbols, the repeater does not perform at least one of the following operations: uplink reception, uplink forwarding, downlink reception and downlink forwarding. That is, in this example, the repeater starts uplink reception and/or uplink forwarding at the starting of the first symbol (the second uplink symbol) after the downlink-uplink switching interval.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the downlink-uplink switching time after the downlink symbols (for example, consecutive downlink symbols) is located; the NCR-Amplifier of the repeater does not perform downlink reception and/or downlink forwarding (and/or uplink reception and/or uplink forwarding) in the NCR-Amplifier symbols overlapping with these time domain resources.

FIG. 11B illustrates an example of a repeater transmitting and/or receiving signal according to an embodiment of the present disclosure. Due to the limitation of hardware, the repeater needs a certain time for uplink-downlink switching. Specifically, the NCR-Amplifier needs a certain time T_{UL-DL} to perform uplink-downlink switching (uplink-to-downlink switching). The value of T_{UL-DL} can be predefined (for example, 1 symbol, 1 ms); the value of T_{UL-DL} can also be reported to the base station based on the capability report (of the terminal); alternatively, the value of T_{UL-DL} can also be one configured by the base station for the repeater among a plurality of values based on the (terminal) capability report. The unit corresponding to T_{UL-DL} can be an absolute time, for example, millisecond, microsecond, sample point (T_{c}); the unit corresponding to T_{UL-DL} can also be a slot, a symbol. In addition, T_{UL-DL} can be the same as T_{DL-UL} (T_{UL-DL} and T_{DL-UL} correspond to the same parameters). In the example of FIG. 11B, T_{UL-DL} is two symbols, and the subcarrier spacing corresponding to the symbols is the reference subcarrier spacing (provided by referenceSubcarrierSpacing in tdd-UL-DL-ConfigurationCommon).

In this case, during the T_{UL-DL} symbols following the ending of the consecutive uplink symbols, the repeater does not perform at least one of the following operations: downlink reception, downlink forwarding, uplink reception and uplink forwarding. That is, in this example, the repeater does not start downlink reception and/or downlink forwarding until the starting of the third downlink symbol.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the uplink downlink switching time after the uplink symbols (for example, consecutive uplink symbols) is located (without considering TA); the NCR-Amplifier of the repeater does not perform downlink reception and/or downlink forwarding (and/or uplink reception and/or uplink forwarding) in the NCR-Amplifier symbols overlapping with these time domain resources.

### Example 7 (Time Resources for NCR-MT)

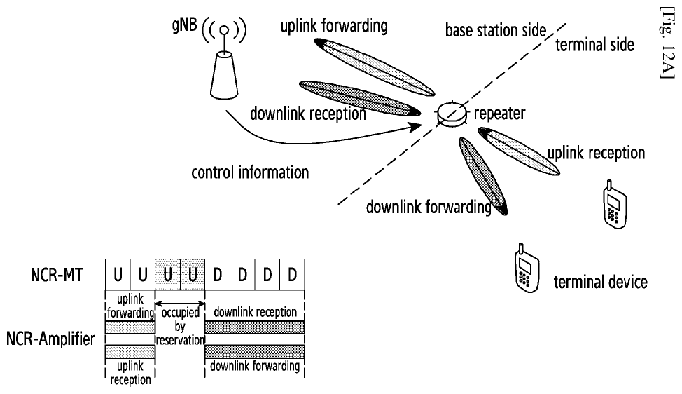

FIG. 12A illustrates an example of a repeater transmitting and/or receiving signal according to an embodiment of the present disclosure. For one type of the repeater, (especially the repeater in which the NCR-MT and the NCR-Amplifier share a radio frequency link,) the NCR-Amplifier and NCR-MT cannot perform transmission at the same time. Take NCR-MT uplink transmission and NCR-Amplifier uplink reception/uplink forwarding as examples. The repeater determines that second time domain resources are configured (or indicated or reserved) as resources for NCR-MT uplink transmission. The repeater does not perform uplink reception and/or uplink forwarding on the resources. Alternatively, the repeater only performs the uplink reception and/or uplink forwarding of the repeater (NCR-Amplifier) on the first two uplink symbols.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources reserved for the NCR-MT (for example, the uplink symbols reserved for the NCR-MT, without considering TA); the NCR-Amplifier of the repeater does not perform downlink reception and/or downlink forwarding (and/or uplink reception and/or uplink forwarding) in the NCR-Amplifier symbol overlapping with these time domain resources.

FIG. 12B illustrates an example of a repeater transmitting and/or receiving signal according to an embodiment of the present disclosure. Unlike the above example, TA is considered in this example, that is, the grid corresponding to the uplink symbols is advanced by T_{TA}. In this case, the repeater refers to the downlink grid and determines the symbols overlapping with the occupied/reserved uplink symbols. The repeater only performs the uplink reception and/or uplink forwarding of the repeater (NCR-Amplifier) on the first uplink symbol.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources reserved for the NCR-MT (for example, the uplink symbols reserved for the NCR-MT, considering TA); the NCR-Amplifier of the repeater does not perform downlink reception and/or downlink forwarding (and/or uplink reception and/or uplink forwarding) in the NCR-Amplifier symbol overlapping with these time domain resources.

The repeater can obtain the information of the second time domain resources in the following ways:
#1: The repeater obtains the starting position (for example, starting symbol) and the duration (symbol duration, symbol length) of the second time domain resources according to the information configured by the base station; further, a periodicity (for example, the periodicity of the time domain resources corresponding to the above-mentioned starting symbol and length) may also be included.
#2: Time domain resources corresponding to “uplink” symbols and/or “downlink” symbols in slot format information (e.g., tdd-UL-DL-ConfigurationDedicated) are configured by repeater according to UE-specific information.
#3: According to the configuration information or indication information from the base station, the repeater determines the time domain resources (the second time domain resource) for the NCR-MT to transmit the corresponding signal or channels, for example, the time domain resources for the uplink channels or signal (e.g., PUCCH/PUSCH/PRACH/SRS) determined by NCR-MT according to the indication information of the base station.

### Example 8 (Switching Time Between the NCR-MT and the NCR-Amplifier)

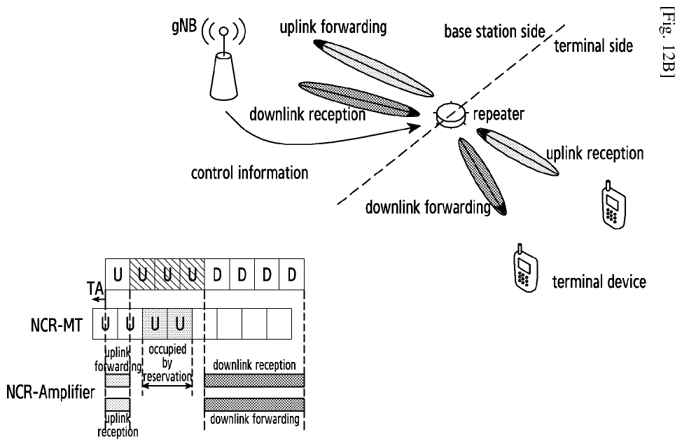

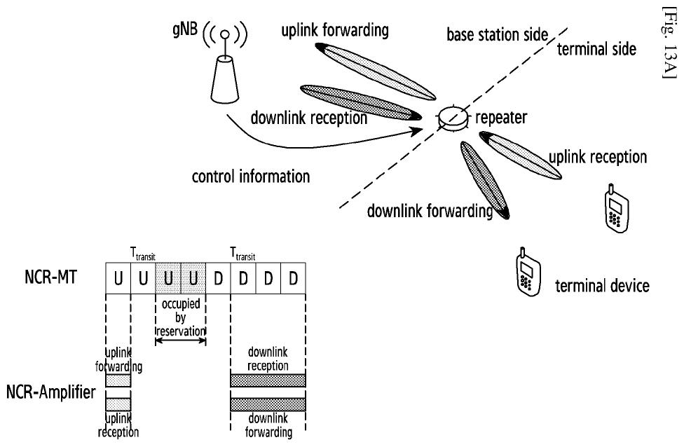

FIG. 13A illustrates another example of a repeater transmitting and/or receiving signal according to an embodiment of the present disclosure. As for the repeater in which NCR-MT and NCR-Amplifier cannot perform transmission at the same time, since the switching between NCR-MT and NCR-Amplifier is required, zero delay switching is not possible for certain repeaters, so it is necessary to consider the switching time Tₜᵣₐₙₛᵢₜ. In addition, the time for switching from NCR-MT to NCR-Amplifier and the time for switching from NCR-Amplifier to NCR-MT may be the same or different. Here, take the time for switching from NCR-MT to NCR-Amplifier and the time for switching from NCR-Amplifier to NCR-MT being the same as an example. The unit corresponding to Tₜᵣₐₙₛᵢₜ can be an absolute time, for example, millisecond, microsecond, sample point (T_{c}); the unit corresponding to Tₜᵣₐₙₛᵢₜ can also be a slot, a symbol; here, take a symbol as an example.

As shown in FIG. 13A, like Example 7 as shown in FIG. 12A and FIG. 12B, the difference is that NCR-MT and NCR-Amplifier need switching time of 1 symbol. That is, Tₜᵣₐₙₛᵢₜ is equal to 1 symbol. The subcarrier spacing corresponding to the symbol is the reference subcarrier spacing (provided by referenceSubcarrierSpacing in tdd-UL-DL-ConfigurationCommon).

In this case, the repeater does not perform at least one of the following operations: downlink reception, downlink forwarding, uplink reception and uplink forwarding during Tₜᵣₐₙₛᵢₜ symbols following the ending of the resources for NCR-MT uplink transmission (or downlink reception). That is, in this example, the repeater does not start downlink reception and/or downlink forwarding until the starting of the second downlink symbol.

In this case, the repeater does not perform at least one of the following operations: downlink reception, downlink forwarding, uplink reception and uplink forwarding, during Tₜᵣₐₙₛᵢₜ symbols preceding the starting of the resources for NCR-MT uplink transmission (or downlink reception). That is, in this example, the repeater does not start uplink reception and/or uplink forwarding until the starting of the first uplink symbol.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources for NCR-MT and NCR-Amplifier switching (for example, the unit is an uplink symbol, without considering TA); the NCR-Amplifier of the repeater does not perform downlink reception and/or downlink forwarding (and/or uplink reception and/or uplink forwarding) in the NCR-Amplifier symbol overlapping with these time domain resources.

FIG. 13B illustrates another example of a repeater transmitting and/or receiving signal according to an embodiment of the present disclosure. Unlike the above example, TA is considered in this example, that is, the grid corresponding to the uplink symbols is advanced by T_{TA}. In this case, the repeater refers to the downlink grid, and determines the symbols that overlap with the time domain resources (and/or occupied/reserved uplink symbols) corresponding to Tₜᵣₐₙₛᵢₜ. On these symbols, the repeater does not perform at least one of the following operations: downlink reception, downlink forwarding, uplink reception and uplink forwarding. Alternatively, the repeater only performs the downlink reception and/or downlink forwarding of the repeater (NCR-Amplifier) on the last three downlink symbols.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources for NCR-MT and NCR-Amplifier switching (for example, the unit is an uplink symbol, considering TA); the NCR-Amplifier of the repeater does not perform downlink reception and/or downlink forwarding (and/or uplink reception and/or uplink forwarding) in the NCR-Amplifier symbols overlapping with these time domain resources.

### Embodiment 2 (Reference Uplink Grid, the Repeater Turns On/Transmits Signal)

It is further explained by the following examples.

In the TDD frequency band (unpaired frequency spectrum), the repeater establishes a connection with the base station through the NCR-MT, wherein, the time unit (granularity) used for the NCR-MT to receive downlink signal can be determined by the following ways (in addition, the time unit used for at least one of downlink reception, downlink forwarding, uplink reception and uplink forwarding of the NCR-Amplifier can also be determined by the following ways). The time unit can be a frame, a sub-frame, a slot, a sub-slot and a symbol, wherein, the sub-carrier spacing (SCS) corresponding to the slot, sub-slot and symbol can be determined according to at least one of the following ways:
reference subcarrier spacing. For example, reference subcarrier spacing indication (referenceSubcarrierSpacing) in TDD configuration information (tdd-UL-DL-ConfigurationCommon). Furthermore, the TDD configuration information is used for the PCell of the NCR-MT.
subcarrier spacing of the SSB; furthermore, the SSB is related to the NCR-MT. For example, the subcarrier spacing of the SSB corresponding to the latest PRACH transmission by the NCR-MT; for another example, the base station indicates the TCI state of CORESET #0 via MAC-CE signaling, and the TCI state corresponds to the SSB.
the subcarrier spacing is predetermined, for example, 15 kHz, 30 kHz, 60 kHz, 120 kHz, 240 kHz.
the subcarrier spacing is related to a frequency range; furthermore, the sub-carrier spacings for different frequency ranges can be configured (defined) respectively, where these frequency ranges include FR1 and FR2 (FR2-1 and FR2-2, refer to the existing specification for the meaning). For example, the subcarrier spacing is 15 kHz for FR1; the subcarrier spacing is 60 kHz for FR2.
sub-carrier spacing corresponding to CORESET #0 of the NCR-MT.
subcarrier spacing corresponding to the initial UL BWP of the NCR-MT. For example, subCarrierSpacingCommon in MIB.

In addition, in Embodiment 2, the reference uplink grid can be understood as the reference uplink time domain unit (uplink frame, uplink subframe, uplink slot and uplink symbol) (of the NCR-MT).

In Embodiment 2, the reference uplink grid can also be understood as the reference time domain unit (frame, subframe, slot, symbol) used (by the NCR-MT) for uplink transmission.

In Embodiment 2, the reference uplink grid can be understood as a grid in which the TA of the uplink time domain unit (the uplink slot and the uplink symbol) being related to (the same as) the uplink TA corresponding to the NCR-MT.

In addition, in Embodiment 2, the reference uplink grid can also be understood as a grid in which the TA of the flexible time domain unit (the flexible symbol) being related to (the same as) the uplink TA corresponding to the NCR-MT.

In the FDD frequency band (paired spectrum), the repeater establishes a connection with the base station through the NCR-MT, wherein, the time unit for the NCR-MT to receive downlink signal can be determined in the following ways (in addition, the time unit for at least one of downlink reception, downlink forwarding, uplink reception and uplink forwarding of the NCR-Amplifier can also be determined in the following ways), where the time unit can be a frames, a subframe, a slot, a sub-slot and a symbol, wherein, the sub-carrier spacing (SCS) corresponding to the slot, sub-slot and symbol can be determined according to at least one of the following ways:
subcarrier spacing of the SSB; furthermore, this SSB is related to the NCR-MT. For example, the subcarrier spacing of the SSB corresponding to the latest PRACH transmission by the NCR-MT; for another example, the base station indicates the TCI state of CORESET #0 via MAC-CE signaling, and the TCI state corresponds to the SSB.
the subcarrier spacing is predetermined, for example, 15 kHz, 30 kHz, 60 kHz.
sub-carrier spacing corresponding to CORESET #0 of the NCR-MT.
subcarrier spacing corresponding to the initial UL BWP of the NCR-MT. For example, subCarrierSpacingCommon in MIB.

Refer to Embodiment 1 for definition and description of T_{diff}, T_{diff,DL}, T_{diff,UL}, T_{diff,ul}.

### Example 1 (FDD Scenario, Repeater Off to On)

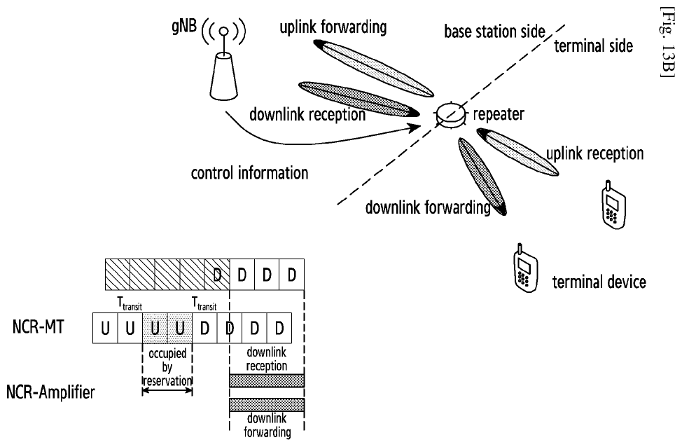

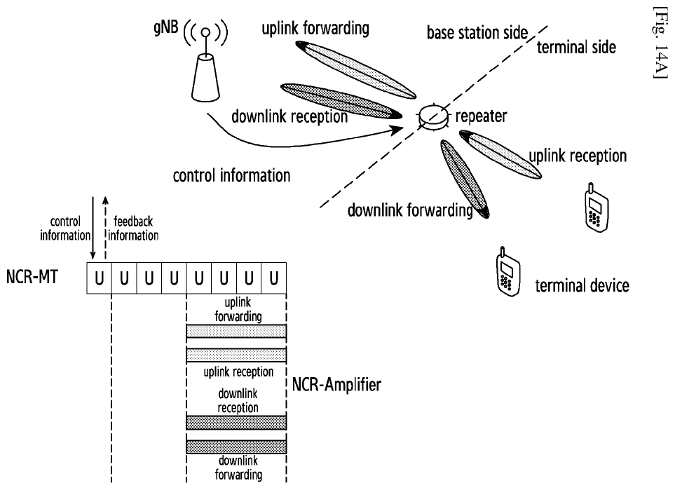

FIG. 14A illustrates an example of a repeater transmitting and/or receiving signal according to an embodiment of the present disclosure. In the following example, in the FDD spectrum, how a repeater is turned on after receiving control information is explained. Being in the FDD spectrum can be understood as the repeater NCR-Amplifier operating in the FDD spectrum. In this example, the time unit used by the NCR-MT for uplink transmission is a slot. The subcarrier spacing corresponding to the slot is the subcarrier spacing corresponding to the initial DL/UL BWP of the NCR-MT (provided by MIB in subCarrierSpacingCommon).

As shown in FIG. 14A, the repeater establishes a connection with the base station through the NCR-MT, obtains the subcarrier spacing corresponding to the uplink slot (the slot used for uplink signal transmission) through system information (for example, subCarrierSpacingCommon in MIB), and determines the uplink slot boundaries. Specifically, FIG. 14A includes eight slots, namely, slot #1 to slot #8 in sequence. At first, the repeater (NCR-Amplifier) is in off state. The NCR-MT of the repeater receives the control information from the base station in the first slot (or transmits the feedback corresponding to the base station control information in the first slot). Specifically, the control information is used to turn on (or activate) the repeater (NCR-Amplifier). After the reception of the control information, more specifically, after a period of time (e.g., 3 ms, three slots) following the reception the control information (or transmission of the feedback information for the control information), the repeater (NCR-Amplifier) starts to perform at least one of the following actions: downlink reception; downward forwarding; uplink reception; uplink forwarding. The above example can also be understood that the time unit corresponding to the downlink reception, downlink forwarding, uplink reception and/or uplink forwarding of the NCR-Amplifier is a slot, where the subcarrier spacing corresponding to the slot is the subcarrier spacing corresponding to the initial DL BWP of the NCR-MT (provided by MIB in subCarrierSpacingCommon). In addition, take T_{diff}=0 as an example in this example. That is, the reception/transmission grid of the NCR-Amplifier and the downlink reception grid of the NCR-MT are aligned (for example, the boundaries of slots/subframes are aligned).

FIG. 14B illustrates an example of a repeater transmitting and/or receiving signal according to an embodiment of the present disclosure. As shown in FIG. 14B, the (UE-specific) subcarrier spacing of the control information transmitted by the NCR-MT is a first subcarrier spacing (for example, 30 kHz); the time unit of the repeater NCR-Amplifier is a slot, and the subcarrier spacing of this slot is determined by the subcarrier spacing corresponding to the initial DL/UL BWP of the NCR-MT (for example, 15 kHz). In addition, take T_{diff}=0 as an example in this example. In this case, in the first NCR-Amplifier slot after a period of time (for example, 3 ms, three NCR-MT slots following the slot related to transmitting the feedback for control information) following the NCR-MT slot transmitting the feedback for the control information, the repeater (NCR-Amplifier) starts to perform at least one of the following actions: downlink reception; downward forwarding; uplink reception; uplink forwarding.

It should be noted that the above method for turning on the repeater (NCR-Amplifier) is also applicable to the TDD frequency band. That is, the method provided by this example can be used in combination with the methods provided by the following examples.

### Example 2 (TDD Scenario)

The following example illustrates how a repeater transmits and/or receives signal according to the slot format information. In this example, take the time unit used by NCR-MT for uplink transmission being a symbol as an example. Wherein, the subcarrier spacing corresponding to the symbol is the reference subcarrier spacing (provided by referenceSubcarrierSpacing in tdd-UL-DL-ConfigurationCommon).

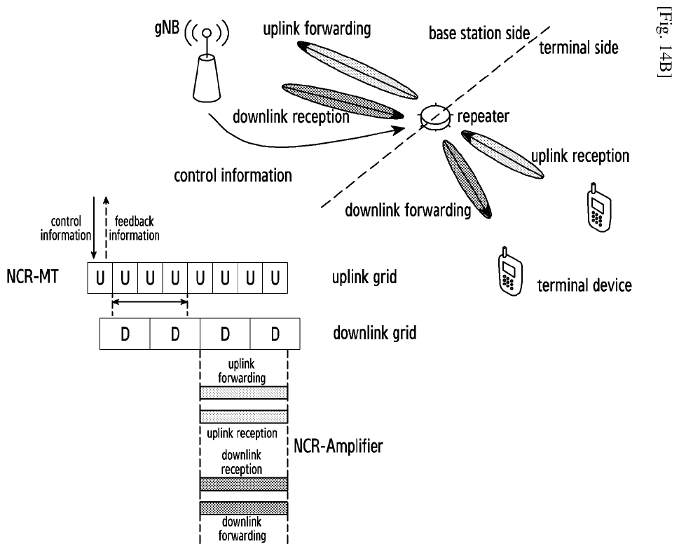

FIG. 15 illustrates an example of a repeater transmitting and/or receiving signal according to an embodiment of the present disclosure. As shown in FIG. 15, according to the above description, the repeater establishes a connection with the base station through the NCR-MT and obtains TDD configuration information. Here, the TDD configuration information is used to indicate which symbols are uplink, downlink or flexible. Specifically, the Figure includes 8 symbols (refer to the downlink reception slots/grid of the NCR-MT), which are symbol #1 to symbol #8 in sequence. According to the slot format information (for example, the slot format information is determined according to at least one of UE-specific information, cell-common information and group-common information; herein, take the slot format information being determined according to cell-common information as an example), the first four symbols are downlink (D), the fifth to sixth symbols are flexible (F), and the last two symbols are uplink (U). For the repeater, the operation of downlink reception and/or downlink forwarding on the time domain resources related to downlink symbols is the same as Example 4 of Embodiment 1. In addition, uplink reception and/or uplink forwarding are performed on time domain resources related to uplink symbols. The grid referenced by the uplink symbols needs to consider the timing advance corresponding to the NCR-MT. The method for determining the timing advance can be referred to the related art. That is, the uplink transmission grid (transmission time) is earlier than the downlink reception grid (reception time) by T_{TA}. In this time, the repeater (NCR-Amplifier) performs uplink reception and/or uplink forwarding on the uplink symbols (seventh symbol and eighth symbol) corresponding to the uplink grid.

More specifically:
The starting time of uplink reception of the NCR-Amplifier is the same as the starting time of the seventh symbol corresponding to the uplink grid; or, take the uplink slots of the NCR-MT as reference, the NCR-Amplifier starts uplink reception at the starting of the first symbol of consecutive uplink symbols; or, take the uplink slots of the NCR-MT as reference, the NCR-Amplifier starts uplink reception no later than the starting of the first symbol of consecutive uplink symbols.
The ending time of uplink reception of the NCR-Amplifier is the same as the ending time of the eighth symbol corresponding to the uplink grid; or, take the uplink slots of the NCR-MT as reference, the NCR-Amplifier stops uplink reception at the ending of the last symbol of consecutive uplink symbols; or, take the uplink slots of the NCR-MT as reference, the NCR-Amplifier stops uplink reception no later than the ending of the last symbol of consecutive uplink symbols.
The starting time of uplink forwarding of the NCR-Amplifier is the same as the starting time of the seventh symbol corresponding to the uplink grid; or, take the uplink slots of the NCR-MT as reference, the NCR-Amplifier starts uplink reception at the starting of the first symbol of consecutive uplink symbols; or, take the uplink slots of the NCR-MT as reference, the NCR-Amplifier starts uplink reception no later than the starting of the first symbol of consecutive uplink symbols.
The ending time of uplink forwarding of the NCR-Amplifier is the same as the ending time of the eighth symbol corresponding to the downlink grid; or, take the uplink slots of the NCR-MT as reference, the NCR-Amplifier stops uplink reception at the ending of the last symbol of consecutive uplink symbols; or, take the uplink slots of the NCR-MT as reference, the NCR-Amplifier stops uplink reception no later than the ending of the last symbol of consecutive uplink symbols.

In addition, it should be noted that, in the above example, a variant can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the downlink symbols (for example, consecutive downlink symbols) are located, and the NCR-Amplifier of the repeater performs downlink reception and/or forwarding in the NCR-Amplifier symbols overlapping with these time domain resources. In addition, the NCR-MT of the repeater determines the time domain resources where uplink symbols (for example, consecutive uplink symbols) are located (considering TA), and the NCR-Amplifier of the repeater performs uplink reception and/or forwarding in the NCR-Amplifier symbols overlapping with these time domain resources.

### Example 3 (UL Guard Period)

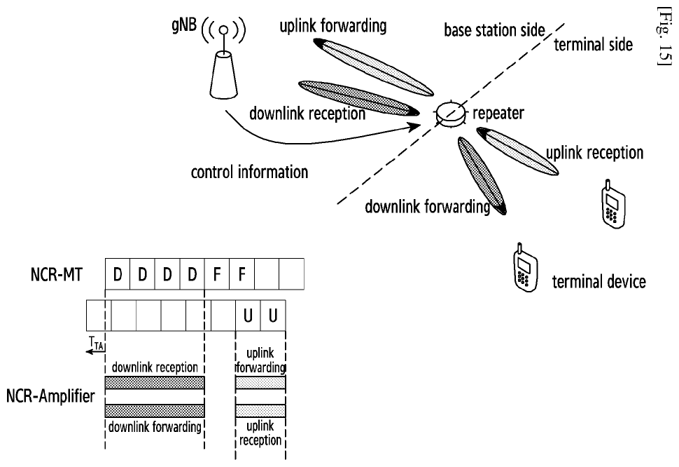

FIG. 16 illustrates an example of a repeater transmitting and/or receiving signal according to an embodiment of the present disclosure, similar to the description of Example 5 of Embodiment 1. In this example, T_{ext,1} is one symbol, and T_{ext,2} is two symbols. T_{ext,1} and T_{ext,2} take the uplink grid (uplink time units, uplink slots) corresponding to the NCR-MT as reference. According to the above description, the repeater determines the seventh to tenth symbols corresponding to the uplink grid for uplink reception and uplink forwarding according to the position of the uplink symbol U corresponding to the NCR-MT and T_{ext,1} and T_{ext,2}. That is, the NCR-Amplifier starts uplink forwarding and/or uplink reception at the starting of the first symbol (the seventh symbol corresponding to the uplink grid) determined by T_{ext,1}; the NCR-Amplifier stops uplink forwarding and/or uplink reception at the ending of the last symbol (the tenth symbol corresponding to the uplink grid) determined by T_{ext,2}.

In addition, it should be noted that in the above example, it can be understood that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the uplink symbols (for example, consecutive uplink symbols) and the corresponding uplink guard periods are located (considering TA), and the NCR-Amplifier of the repeater performs uplink reception and/or forwarding in the NCR-Amplifier symbols overlapping with these time domain resources. It should be noted that the method involving the uplink guard periods in Example 3 is also applicable to the method involving the downlink guard periods. That is, the method provided by this Example 3 can be applied in a similar way to the case where there are downlink guard periods. In addition, the “uplink guard periods” in this disclosure can also be called “uplink extension time”; “downlink guard periods” can also be called “downlink extension time”.

### Example 4 (DL/UL Direction Switching)

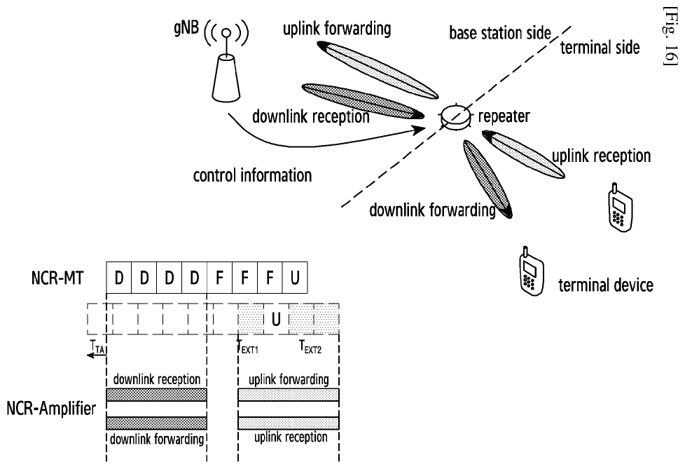

FIG. 17A illustrates an example of a repeater transmitting and/or receiving signal according to an embodiment of the present disclosure. Referring to the scenario of Example 2, the repeater needs a certain time for uplink-downlink switching due to hardware limitations. Specifically, the NCR-Amplifier needs a certain time T_{DL-UL} to perform downlink-uplink switching (downlink-to-uplink switching). The value of T_{DL-UL} can be predefined (for example, 1 symbol, 1 ms); the value of T_{DL-UL} can also be reported to the base station based on the (terminal) capability report, or the value of T_{DL-UL} may be one configured by the base station for the repeater among a plurality of values based on the (terminal) capability report. In addition, the unit corresponding to T_{DL-UL} can be an absolute time, for example, millisecond, microsecond, sample point (Tc); the unit corresponding to T_{DL-UL} can also be a slot, a symbol. In the example of FIG. 17A, T_{DL-UL} is one symbol, and the subcarrier spacing corresponding to this symbol is the reference subcarrier spacing (provided by referenceSubcarrierSpacing in tdd-UL-DL-ConfigurationCommon).

In this case, during the T_{DL-UL} symbols after the ending of the consecutive downlink symbols, the repeater (NCR-Amplifier) does not perform at least one of the following operations on the uplink symbols overlapping with this symbol: uplink reception, uplink forwarding, downlink reception and downlink forwarding. That is, in this example, take the uplink grid as reference, the repeater starts uplink reception and/or uplink forwarding at the starting of the first symbol (the second uplink symbol) after the downlink-uplink direction switching interval. Here, the time domain positions of the uplink symbols refer to the uplink grid (TA needs to be considered).

In addition, it should be noted that in the above example, a variant may be that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the uplink downlink switching time after the downlink symbols (for example, consecutive downlink symbols) is located; the NCR-Amplifier of the repeater does not perform downlink reception and/or downlink forwarding (and/or uplink reception and/or uplink forwarding) in the NCR-Amplifier symbols overlapping with these time domain resources.

FIG. 17B illustrates an example of a repeater transmitting and/or receiving signal according to an embodiment of the present disclosure. FIG. 17B is a variant of the above example. The repeater needs a certain time for uplink-downlink switching due to the limitation of hardware. Specifically, the NCR-Amplifier needs a certain time T_{UL-DL} to perform uplink-downlink switching (uplink-to-downlink switching). The value of T_{UL-DL} can be predefined (for example, 1 symbol, 1 ms); the value of T_{UL-DL} can also be reported to the base station based on the (terminal) capability report; alternatively, the value of T_{UL-DL} can also be one configured by the base station for the repeater among a plurality of values based on the (terminal) capability report. In addition, the unit corresponding to T_{UL-DL} can be an absolute time, for example, millisecond, microsecond, sample point (Tc); the unit corresponding to T_{UL-DL} can also be a slot, a symbol. In addition, T_{UL-DL} can be the same as T_{DL-UL} (T_{UL-DL} and T_{DL-UL} correspond to the same parameter). In the example of FIG. 17B, T_{UL-DL} is one symbol, and the subcarrier spacing corresponding to this symbol is the reference subcarrier spacing (provided by referenceSubcarrierSpacing in tdd-UL-DL-ConfigurationCommon).

In this case, during the T_{UL-DL} symbols after the ending of the consecutive uplink symbols, the repeater does not perform at least one of the following operations on the downlink symbol overlapping with this symbol: uplink reception, uplink forwarding, downlink reception and downlink forwarding. That is, in this example, take the downlink grid as reference, the repeater starts downlink reception and/or downlink forwarding at the starting of the first symbol (the second uplink symbol) after the uplink-downlink direction switching interval. Here, the time domain positions of the uplink symbols (and/or the T_{UL-DL} symbols after the ending of uplink symbols) refer to the uplink grid (TA needs to be considered).

In addition, it should be noted that in the above example, a variant may be that the time unit corresponding to the downlink reception, downlink forwarding, uplink reception and/or uplink forwarding of the NCR-Amplifier is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the uplink downlink switching time after the uplink symbols (for example, consecutive uplink symbols) is located; the NCR-Amplifier of the repeater does not perform downlink reception and/or downlink forwarding (and/or uplink reception and/or uplink forwarding) in the NCR-Amplifier symbols overlapping with these time domain resources.

### Example 5 (Time Resources for the NCR-MT)

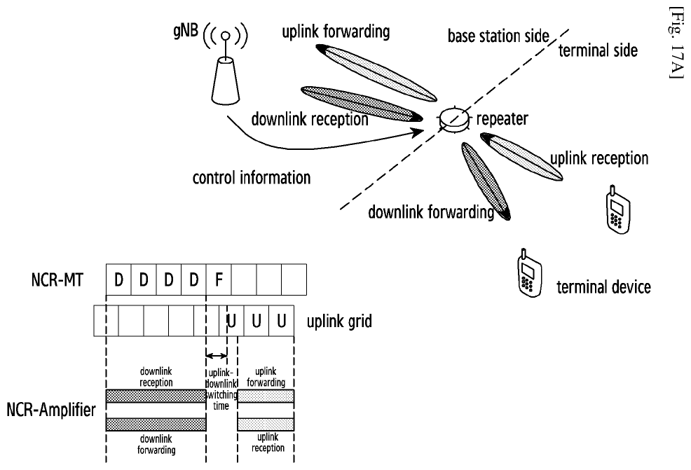

FIG. 18 illustrates an example of a repeater transmitting and/or receiving signal according to an embodiment of the present disclosure. FIG. 18 is similar to Example 7 of Embodiment 1, except that the uplink reception and/or uplink forwarding timing of the repeater (NCR-Amplifier) is determined according to the uplink grid of the NCR-MT. That is, take the uplink grid of the NCR-MT as reference, the NCR-Amplifier does not perform uplink forwarding and/or uplink reception on the time resources (symbols) reserved for (occupied by) the NCR-MT, or the NCR-Amplifier performs uplink forwarding and/or uplink reception on the first two symbols corresponding to the uplink grid.

### Example 6 (Switching Time Between the NCR-MT and the NCR-Amplifier)

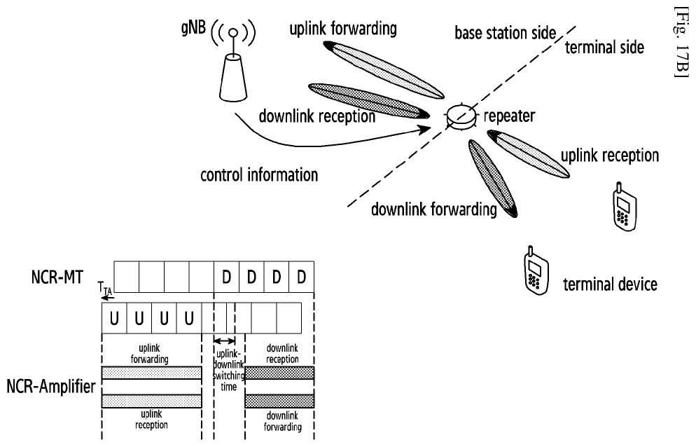

FIG. 19 illustrates an example of a repeater transmitting and/or receiving signal according to an embodiment of the present disclosure. FIG. 19 is similar to Example 8 of Embodiment 1, except that the uplink reception and/or uplink forwarding timing of the repeater (NCR-Amplifier) is determined according to the uplink grid of the NCR-MT. That is, take the uplink grid of the NCR-MT as reference, the NCR-Amplifier does not perform uplink forwarding and/or uplink reception on the time resources (symbols) reserved for (occupied by) the NCR-MT and the switching time resources related to the time resources reserved for the NCR-MT; or, take the uplink grid of the NCR-MT as reference, the NCR-Amplifier performs uplink forwarding and/or uplink reception on the first symbol; or, take the downlink grid of the NCR-MT as reference, the NCR-Amplifier performs downlink forwarding and/or downlink reception on the sixth symbol to the eighth symbol.

### Embodiment 3 (Reference Downlink Grid, the Repeater is Turned Off/does not Transmit Signal)

For further explanation of the time unit of the NCR-MT (or NCR-Amplifier), refer to Embodiment 1. Redundant description is omitted here.

### Example 1 (FDD Scenario, Repeater On to Off)

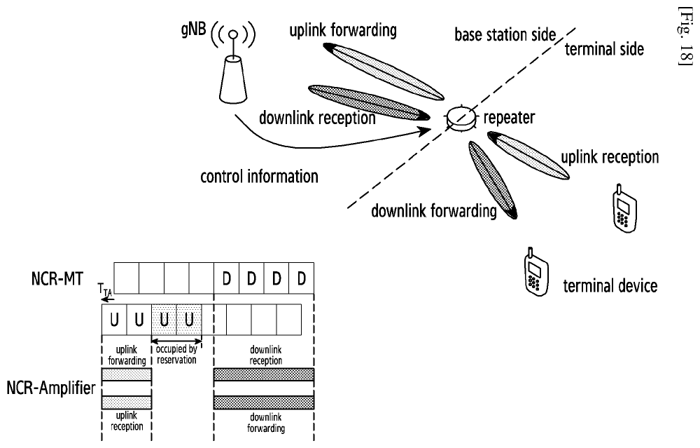

FIG. 20 illustrates an example of a repeater not transmitting and/or not receiving signal according to an embodiment of the present disclosure. In the following example, in the FDD spectrum, how a repeater is turned on after receiving control information is explained. Being in the FDD spectrum can be understood as the repeater NCR-Amplifier operating in the FDD spectrum. In this example, the time unit used by NCR-MT for downlink reception is a slot. The subcarrier spacing corresponding to the slot is the subcarrier spacing corresponding to the initial BWP of the NCR-MT (provided by MIB in subCarrierSpacingCommon).

As shown in FIG. 20, the repeater establishes a connection with the base station through the NCR-MT, obtains the subcarrier spacing corresponding to the downlink slots through system information (for example, subCarrierSpacingCommon in MIB), and determines the downlink slot boundaries. Specifically, the Figure includes eight slots, namely, slot #1 to slot #8 in sequence. At first, the NCR-Amplifier is in the on state. The NCR-MT of the repeater receives the control information from the base station in the first slot (or transmits the feedback corresponding to the control information of the base station in the first slot). Specifically, the control information is used to turn off (or deactivate) the NCR-Amplifier. After receiving the control information, more specifically, after a period of time (e.g., 3 ms, three slots) following the reception of the control information (or the transmission of the feedback information for the control information), the NCR-Amplifier does not perform (stop) at least one of the following actions: downlink reception; downward forwarding; uplink reception; uplink forwarding. The above example can also be understood that the time unit corresponding to not performing (stopping) downlink reception, downlink forwarding, uplink reception and/or uplink forwarding by the NCR-Amplifier is a slot, where the subcarrier spacing corresponding to the slot is the subcarrier spacing corresponding to the initial DL BWP of the NCR-MT (provided by MIB in subCarrierSpacingCommon). In addition, take T_{diff}=0 as an example in this example. That is, the reception/transmission grid of the NCR-Amplifier and the downlink reception grid of the NCR-MT are aligned (for example, the boundaries of slots/subframes are aligned).

FIG. 20 illustrates an example in which a repeater does not transmit and/or not receive signal according to an embodiment of the present disclosure. As shown in FIG. 20, the (UE-specific) subcarrier spacing of the control information received by the NCR-MT is a first subcarrier spacing (for example, 30 kHz); a time unit of the repeater NCR-Amplifier is for example a slot, the subcarrier spacing of which is determined by the subcarrier spacing of the initial DL BWP of the NCR-MT (for example, 15 kHz). In addition, take T_{diff}=0 as an example in this example. In this case, in the first NCR-Amplifier slot after a period of time (for example, 2 ms, two NCR-MT slots following the slot related to receiving the control information) following the NCR-MT slot in which the control information is received, the repeater (NCR-Amplifier) does not perform (stop) at least one of the following actions: downward forwarding; uplink reception; uplink forwarding. It should be noted that the above method for turning on the NCR-Amplifier is also applicable in the TDD frequency band. That is, the method provided by this example can be used in combination with the methods provided by the following examples.

### Example 2 (TDD Scenario)

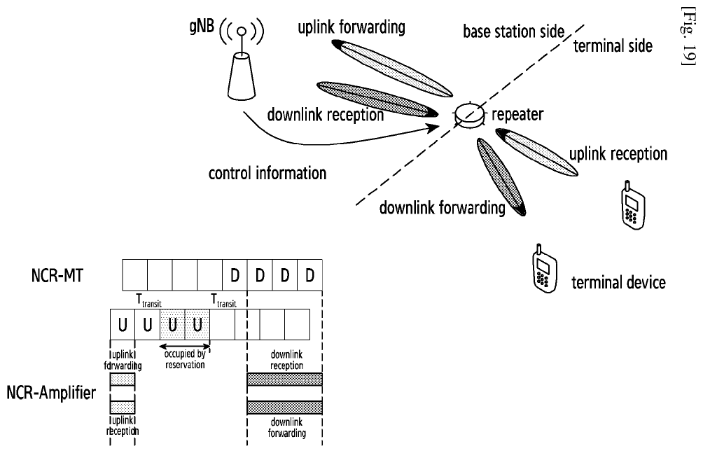

FIG. 21 illustrates an example of a repeater not transmitting and/or not receiving signal according to an embodiment of the present disclosure. The following example illustrates how a repeater does not transmit and/or not receive signal according to the slot format information. In this example, take the time unit used by NCR-MT for downlink reception being a symbol as an example. Wherein, the subcarrier spacing corresponding to the symbol is the reference subcarrier spacing (provided by referenceSubcarrierSpacing in tdd-UL-DL-ConfigurationCommon).

It is further explained by the following examples.

As shown in FIG. 21, according to the above description, the repeater establishes a connection with the base station through the NCR-MT, and obtains TDD configuration information. Here, the TDD configuration information is used to indicate which symbols are uplink, downlink or flexible. Specifically, the Figure includes 8 symbols (refer to the downlink reception slots/grid of the NCR-MT), which are symbol #1 to symbol #8 in sequence. According to the slot format information (for example, the slot format information is determined according to at least one of UE-specific information, cell-common information and group-common information; herein, take the slot format information being determined according to cell-common information as an example), the first four symbols are downlink (D), the fifth symbol is flexible (F), and the last three symbols are uplink (U). For the repeater, at least one of the following operations is not performed (stopped) on the time domain resources related to the flexible symbols: downlink reception, downlink forwarding, uplink reception and uplink forwarding.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the downlink symbols (for example, consecutive downlink symbols) are located, and the NCR-Amplifier of the repeater does not perform (stop) downlink reception and/or not perform (stop) downlink forwarding in the NCR-Amplifier symbols overlapping with these time domain resources. In addition, the NCR-MT of the repeater determines the time domain resources where uplink symbols (for example, consecutive uplink symbols) are located (without considering TA), and the NCR-Amplifier of the repeater does not perform (stop) uplink reception and/or not perform (stop) uplink forwarding in the NCR-Amplifier symbols overlapping with these time domain resources.

### Example 3 (DL/UL Direction Switching)

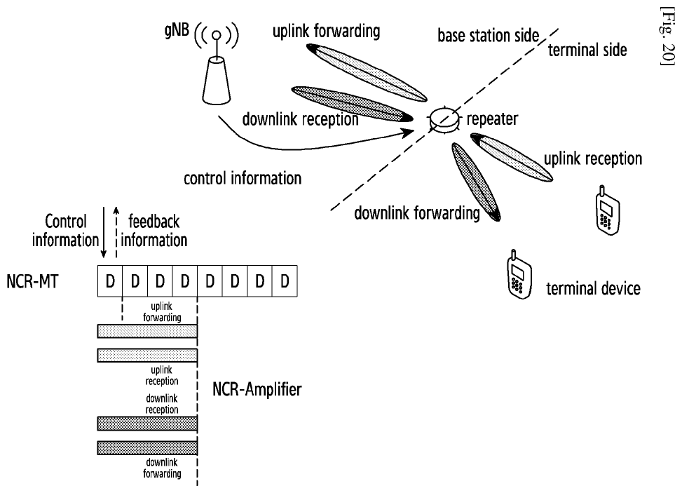

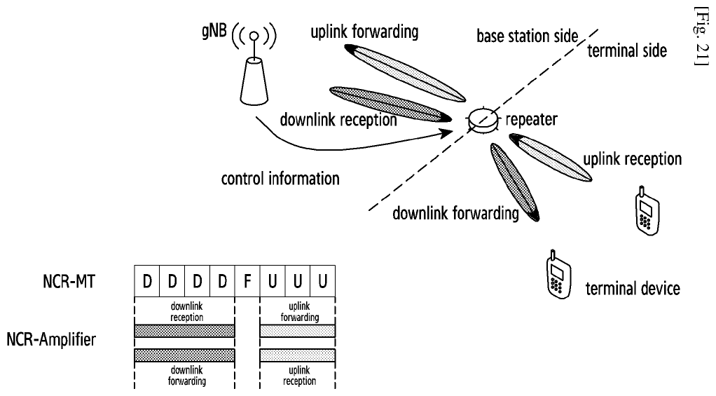

FIG. 22A illustrates an example of a repeater not transmitting and/or not receiving signal according to an embodiment of the present disclosure. Referring to the scenario of Example 2, the repeater needs a certain time to perform downlink-uplink switching due to hardware limitations. Specifically, the NCR-Amplifier needs a certain time T_{DL-UL}to perform downlink-uplink switching (downlink-to-uplink switching). The value of T_{DL-UL} can be predefined (for example, 1 symbol, 1 ms); the value of T_{DL-UL} can also be reported to the base station based on the capability report (of a terminal), or the value of T_{DL-UL} may be one configured by the base station for the repeater among a plurality of values based on the (terminal) capability report. In addition, the unit corresponding to T_{DL-UL} can be an absolute time, for example, millisecond, microsecond, sample point (T_{c}); the unit corresponding to T_{DL-UL} can also be a slot, a symbol. In the example of FIG. 22A, T_{DL-UL} is two symbols, and the subcarrier spacing corresponding to the symbols is the reference subcarrier spacing (provided by referenceSubcarrierSpacing in tdd-UL-DL-ConfigurationCommon).

In this case, during the T_{DL-UL} symbols after the ending of the consecutive downlink symbols, the repeater does not perform (stop) at least one of the following operations: uplink reception, uplink forwarding, downlink reception, and downlink forwarding. That is, in this example, the repeater stops uplink reception and/or uplink forwarding at the starting of the first symbol (the second uplink symbol) after the downlink-uplink direction switching interval.

In addition, it should be noted that in the above example, it can be understood that the corresponding time unit in which NCR-Amplifier does not perform downlink reception, downlink forwarding, uplink reception and/or uplink forwarding, is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the downlink-uplink switching time after the downlink symbols (for example, consecutive downlink symbols) is located; the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbols overlapping with these time domain resources.

FIG. 22B illustrates an example of a repeater not transmitting and/or not receiving signal according to an embodiment of the present disclosure. FIG. 22B is a variant of the above example. Due to the limitation of hardware, the repeater needs a certain time for uplink-downlink switching. Specifically, the NCR-Amplifier needs a certain time T_{UL-DL} to perform uplink-downlink switching (uplink-to-downlink switching). The value of T_{UL-DL} can be predefined (for example, 1 symbol, 1 ms); the value of T_{UL-DL} can also be reported to the base station based on the (terminal) capability report; alternatively, the value of T_{UL-DL} can also be one configured by the base station for the repeater among a plurality of values based on the (terminal) capability report. In addition, the unit corresponding to T_{UL-DL} can be an absolute time, for example, millisecond, microsecond, sample point (Tc); the unit corresponding to T_{UL-DL} can also be a slot, a symbol. In addition, T_{UL-DL} can be the same as T_{DL-UL} (T_{UL-DL} and T_{DL-UL} correspond to the same parameter). In the example of FIG. 22B, T_{UL-DL} is two symbols, and the subcarrier spacing corresponding to the symbols is the reference subcarrier spacing (provided by referenceSubcarrierSpacing in tdd-UL-DL-ConfigurationCommon).

In this case, during the T_{UL-DL} symbols after the ending of the consecutive uplink symbols, the repeater does not perform (stop) at least one of the following operations: downlink reception, downlink forwarding, uplink reception, and uplink forwarding.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources where the uplink-downlink switching time after the uplink symbols (for example, consecutive uplink symbols) is located (without considering TA); the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbols overlapping with these time domain resources.

### Example 4 (Time Resources for the NCR-MT)

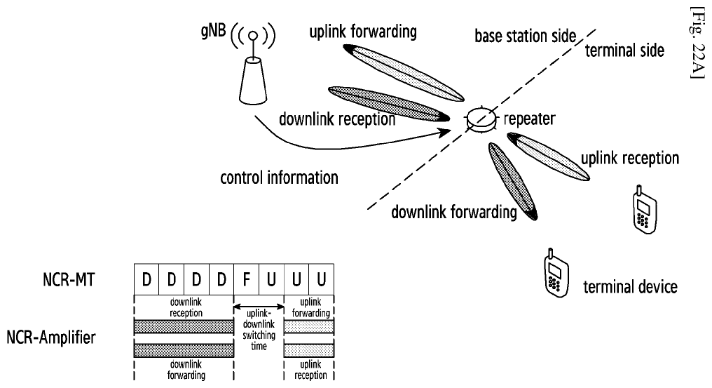

FIG. 23A illustrates another example of a repeater not transmitting and/or not receiving signal according to an embodiment of the present disclosure. For one type of the repeater, (especially the repeater in which the NCR-MT and the NCR-Amplifier share a radio frequency link,) the NCR-Amplifier and NCR-MT cannot perform transmission at the same time. Take uplink transmission of the NCR-MT and uplink reception/uplink forwarding of the NCR-Amplifier as examples. The repeater determines that second time domain resources are configured (or indicated; or reserved) as resources for NCR-MT uplink transmission. The repeater does not perform (stop) uplink reception and/or does not perform (stop) uplink forwarding on the resources. Alternatively, the repeater only performs the uplink reception and/or uplink forwarding of the NCR-Amplifier on the first two uplink symbols.

In addition, it should be noted that in the above example, it can be understood that the corresponding time unit in which NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources reserved for the NCR-MT (uplink symbols reserved for the NCR-MT, without considering TA); the NCR-Amplifier of the repeater does not perform (stop) downlink reception and/or (stop) downlink forwarding (and/or, does not perform (stop) uplink reception and/or does not perform (stop) uplink forwarding) in the NCR-Amplifier symbols overlapping with the time domain resources.

FIG. 23B illustrates another example where the repeater does not transmit and/or not receive signal according to the embodiment of the present disclosure. FIG. 23B depicts a variant of the above example. Unlike the above example, TA is considered in this example, that is, the grid corresponding to the uplink symbol is advanced by T_{TA}. In this case, the repeater refers to the downlink grid and determines the symbols overlapping with the occupied/reserved uplink symbols. On these symbols, the repeater does not perform (stop) at least one of the following operations: downlink reception, downlink forwarding, uplink reception and uplink forwarding.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, in this example, take T_{diff}=0 as an example.

The NCR-MT of the repeater determines the time domain resources reserved for the NCR-MT (the uplink symbols reserved for the NCR-MT, considering TA); the NCR-Amplifier of the repeater does not perform (stop) downlink reception and/or (stop) downlink forwarding (and/or, does not perform (stop) uplink reception and/or does not perform (stop) uplink forwarding) in the NCR-Amplifier symbols overlapping with this time domain resource.

The repeater can obtain the information of the second time domain resources in the following ways:
#1: The repeater obtains the starting position (for example, starting symbol) and the duration (symbol duration, symbol length) of the second time domain resources according to the information configured by the base station; further, a periodicity (for example, the periodicity of the time domain resources corresponding to the above-mentioned starting symbol and length) may also be included.
2: Time domain resources corresponding to “uplink” symbols and/or “downlink” symbols in slot format information (e.g., tdd-UL-DL-ConfigurationDedicated) are configured by repeater according to UE-specific information.
3: According to the configuration information or indication information from the base station, the repeater determines the time domain resources (the second time domain resource) for the NCR-MT to transmit the corresponding signal or channels; for example, the time domain resources for the uplink channels or signal (e.g., PUCCH/PUSCH) determined by NCR-MT according to the indication information of the base station.

### Example 5 (Switching Time Between the NCR-MT and the NCR-Amplifier)

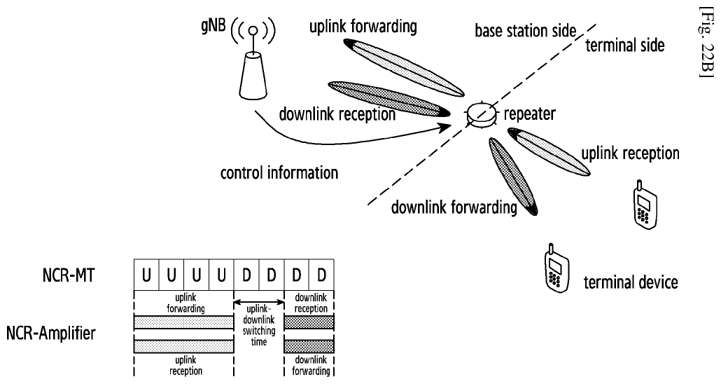

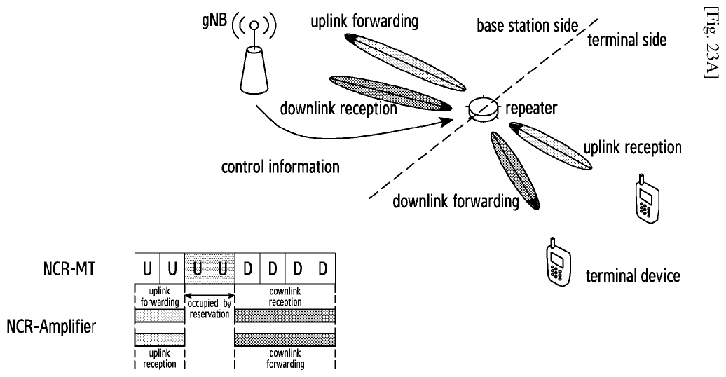

FIG. 24A illustrates an example of a repeater not transmitting and/or not receiving signal according to an embodiment of the present disclosure. As for the repeater in which the NCR-MT and the NCR-Amplifier cannot perform transmission at the same time, since the switching between NCR-MT and NCR-Amplifier is required, zero delay switching is not possible for certain repeaters, so it is necessary to consider the switching time Tₜᵣₐₙₛᵢₜ. In addition, the time for switching from NCR-MT to NCR-Amplifier and the time for switching from NCR-Amplifier to NCR-MT may be the same or different. Here, take the time for switching from NCR-MT to NCR-Amplifier and the time for switching from NCR-Amplifier to NCR-MT being the same as an example. The unit corresponding to Tₜᵣₐₙₛᵢₜ can be an absolute time, for example, millisecond, microsecond, sample point (Tc); the unit corresponding to Tₜᵣₐₙₛᵢₜ can also be a slot, a symbol; here, take a symbol as an example.

As shown in FIG. 24A, like Example 7, the difference is that NCR-MT and NCR-Amplifier need switching time of 1 symbol; that is, Tₜᵣₐₙₛᵢₜ is equal to 1 symbol. The subcarrier spacing corresponding to the symbol is the reference subcarrier spacing (provided by referenceSubcarrierSpacing in tdd-UL-DL-ConfigurationCommon).

In this case, the repeater does not perform (stop) at least one of the following operations: downlink reception, downlink forwarding, uplink reception and uplink forwarding during Tₜᵣₐₙₛᵢₜ symbols following the ending of the resources for NCR-MT uplink transmission (or downlink reception). That is, in this example, the repeater does not start downlink reception and/or downlink forwarding until the starting of the second downlink symbol.

In this case, the repeater does not perform (stop) at least one of the following operations: downlink reception, downlink forwarding, uplink reception and uplink forwarding, during Tₜᵣₐₙₛᵢₜ symbols preceding the starting of the resources for NCR-MT uplink transmission (or downlink reception). That is, in this example, the repeater does not start uplink reception and/or uplink forwarding until the starting of the first uplink symbol.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, in this example, take T_{diff}=0 as an example.

The NCR-MT of the repeater determines the time domain resources for the NCR-MT and NCR-Amplifier switching (for example, the unit is an uplink symbol, without considering TA); the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbol overlapping with the time domain resources.

FIG. 24B illustrates an example of the repeater not transmitting and/or not receiving signal according to the embodiment of the present disclosure. FIG. 24B depicts a variant of the above example. Unlike the above example, TA is considered in this example, that is, the grid corresponding to the uplink symbol is advanced by T_{TA}. In this case, the repeater refers to the downlink grid, and determines the symbols that overlap with the time domain resources (and/or occupied/reserved uplink symbols) corresponding to Tₜᵣₐₙₛᵢₜ. On these symbols, the repeater does not perform (stop) at least one of the following operations: downlink reception, downlink forwarding, uplink reception and uplink forwarding.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=0 as an example in this example.

The NCR-MT of the repeater determines the time domain resources for the NCR-MT and NCR-Amplifier switching (for example, the unit is an uplink symbol, considering TA); the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbol overlapping with the time domain resources.

### Embodiment 4 (Reference Uplink Grid, the Repeater is Turned Off/does not Transmit Signal)

Refer to Example 2 for further explanation of the time unit of the NCR-MT (or NCR-Amplifier). Redundant description is omitted here.

### Example 1 (FDD Scenario, Repeater On to Off)

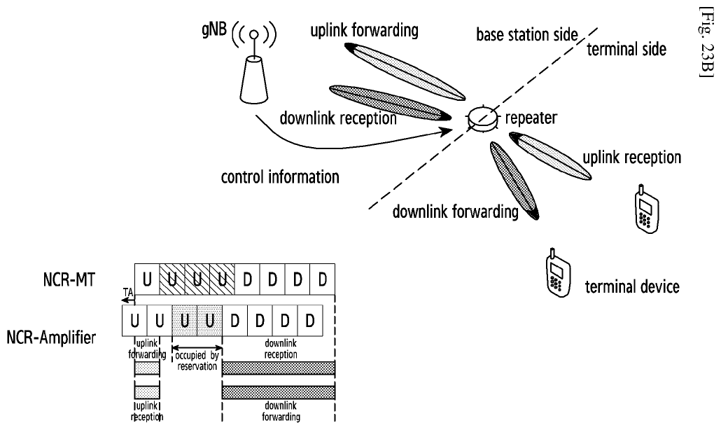

FIG. 25 illustrates an example of a repeater not transmitting and/or not receiving signal according to an embodiment of the present disclosure. In the following example, in the FDD spectrum, how a repeater is turned off after receiving control information is explained. Being in the FDD spectrum can be understood as the repeater NCR-Amplifier operating in the FDD spectrum. In this example, the time unit for the NCR-MT uplink transmission is a slot. The subcarrier spacing corresponding to the slot is the subcarrier spacing corresponding to the initial UL BWP of the NCR-MT (provided by MIB in subCarrierSpacingCommon).

As shown in FIG. 25, the repeater establishes a connection with the base station through the NCR-MT, obtains the subcarrier spacing corresponding to the uplink slot through system information (for example, subCarrierSpacingCommon in MIB) and determines the uplink slot boundaries. Specifically, the Figure includes eight slots, namely, slot #1 to slot #8 in sequence. At first, the NCR-Amplifier is in the on state. The NCR-MT of the repeater receives the control information from the base station in the first slot (or transmits the feedback corresponding to the control information of the base station in the first slot). Specifically, the control information is used to turn off (or deactivate) the NCR-Amplifier. After receiving the control information, more specifically, after a period of time (e.g., 3 ms, three slots) following the reception of the control information (or the transmission of the feedback information for the control information), the NCR-Amplifier stops (does not perform) at least one of the following actions: downlink reception; downward forwarding; uplink reception; uplink forwarding. The above example can also be understood that the time unit corresponding to not performing downlink reception, downlink forwarding, uplink reception and/or uplink forwarding by the NCR-Amplifier is a slot, where the subcarrier spacing corresponding to the slot is the subcarrier spacing corresponding to the initial UL BWP of the NCR-MT (provided by MIB in subCarrierSpacingCommon). In addition, take T_{diff}=0 as an example in this example. That is, the reception/transmission grid of the NCR-Amplifier and the downlink reception grid of the NCR-MT are aligned (for example, the boundaries of subframes are aligned).

FIG. 25 illustrates an example in which a repeater does not transmit and/or not receive signal according to an embodiment of the present disclosure. As shown in FIG. 25, the (UE-specific) subcarrier spacing of the control information transmitted by NCR-MT is a first subcarrier spacing (for example, 30 kHz); a time unit of the repeater NCR-Amplifier is for example a slot, the subcarrier spacing of which is determined by the subcarrier spacing of the initial UL BWP of the NCR-MT (for example, 15 kHz). In addition, take T_{diff}=0 as an example in this example. In this case, in the first NCR-Amplifier slot after a period of time (for example, 2 ms, two NCR-MT slots following the slot related to receiving the control information) following the NCR-MT slot in which the control information is received, the repeater (NCR-Amplifier) does not perform (stop) at least one of the following actions: downward forwarding; uplink reception; uplink forwarding.

It should be noted that the above method of turning on the NCR-Amplifier is also applicable in the TDD frequency band. That is, the method provided by this example can be used in combination with the methods provided by the following examples.

### Example 2 (DL/UL Direction Switching)

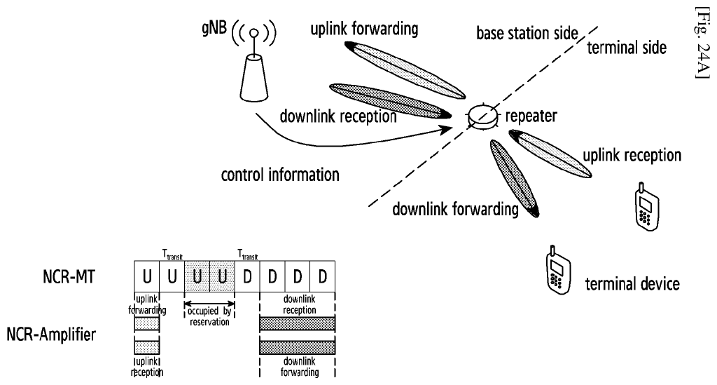

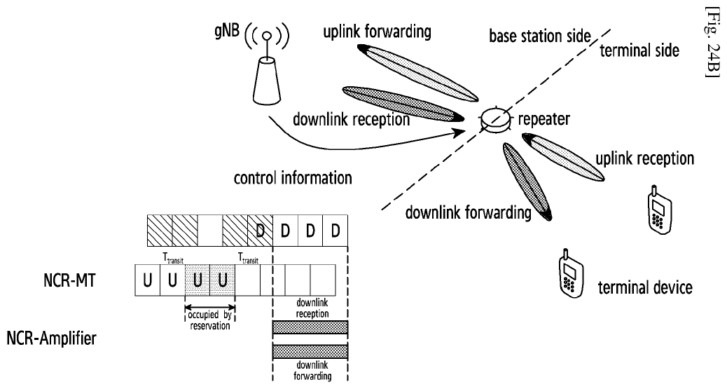

FIG. 26A illustrates an example in which a repeater does not transmit and/or not receive signal according to an embodiment of the present disclosure. Referring to the scenario of Example 2, the repeater needs a certain time for downlink-uplink switching due to hardware limitations. Specifically, the NCR-Amplifier needs a certain time T_{DL-UL} to perform downlink-uplink switching (downlink-to-uplink switching). The value of T_{DL-UL} can be predefined (for example, 1 symbol, 1 ms); the value of T_{DL-UL} can also be reported to the base station based on the capability report (of the terminal), or the value of T_{DL-UL} may be one configured by the base station for the repeater among a plurality of values based on the (terminal) capability report. In the example of FIG. 26A, T_{DL-UL} is one symbol, and the subcarrier spacing corresponding to this symbol is the reference subcarrier spacing (provided by referenceSubcarrierSpacing in tdd-UL-DL-ConfigurationCommon).

In this case, during the T_{DL-UL} symbols after the ending of the consecutive downlink symbols, the repeater does not perform at least one of the following operations on the uplink symbols overlapping with the symbols: uplink reception, uplink forwarding, downlink reception and downlink forwarding. That is, in this example, take the uplink grid as reference, the repeater starts uplink reception and/or uplink forwarding at the starting of the first symbol (the second uplink symbol) after the downlink-uplink direction switching interval. Here, the time domain positions of the uplink symbols refer to the uplink grid (TA needs to be considered).

In addition, it should be noted that in the above example, a variant may be that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the uplink downlink switching time after the downlink symbols (for example, consecutive downlink symbols) is located; the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbols overlapping with this time domain resource.

FIG. 26B illustrates an example of a repeater not transmitting and/or not receiving signal according to an embodiment of the present disclosure. FIG. 26B is a variant of the above example. The repeater needs a certain time for uplink-downlink switching due to the limitation of hardware. Specifically, the NCR-Amplifier needs a certain time T_{UL-DL} to perform uplink-downlink switching (uplink-to-downlink switching). The value of T_{UL-DL} can be predefined (for example, 1 symbol, 1 ms); the value of T_{UL-DL} can also be reported to the base station based on the capability report (of the terminal); alternatively, the value of T_{UL-DL} can also be one configured by the base station for the repeater among a plurality of values based on the (terminal) capability report. In addition, T_{UL-DL} can be the same as T_{DL-UL} (T_{UL-DL} and T_{DL-UL} correspond to the same parameter). In the example of FIG. 26B, T_{UL-DL} is one symbol, and the subcarrier spacing corresponding to this symbol is the reference subcarrier spacing (provided by referenceSubcarrierSpacing in tdd-UL-DL-ConfigurationCommon).

In this case, during the T_{UL-DL} symbols after the ending of the consecutive uplink symbols, the repeater does not perform at least one of the following operations on the downlink symbols overlapping with the symbols: uplink reception, uplink forwarding, downlink reception and downlink forwarding. That is, in this example, take the downlink grid as reference, the repeater does not start the downlink reception and/or downlink forwarding until the starting of the first symbol (the second downlink symbol) after the uplink-downlink direction switching interval. Here, the time domain positions of the uplink symbols (and/or the T_{UL-DL} symbols after the ending of uplink symbols) refer to the uplink grid (TA needs to be considered).

In addition, it should be noted that in the above example, a variant may be that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources where the uplink downlink switching time after the uplink symbols (for example, consecutive uplink symbols) is located; the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbols overlapping with the time domain resources.

### Example 3 (Time Resources for NCR-MT)

FIG. 27 illustrates another example of a repeater not transmitting and/or not receiving signal according to an embodiment of the present disclosure. FIG. 27 is similar to Example 7 of Embodiment 1, except that the uplink reception and/or uplink forwarding timing of the NCR-Amplifier is determined according to the uplink grid of the NCR-MT. That is, take the uplink grid of the NCR-MT as reference, the NCR-Amplifier does not perform uplink forwarding and/or uplink reception (or downlink forwarding and/or downlink reception) on the time resources (symbols) reserved for (occupied by) the NCR-MT.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources reserved for the NCR-MT (the uplink symbols reserved for the NCR-MT, considering TA); the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbol overlapping with this time domain resource.

### Example 4 (Switching Time Between the NCR-MT and the NCR-Amplifier)

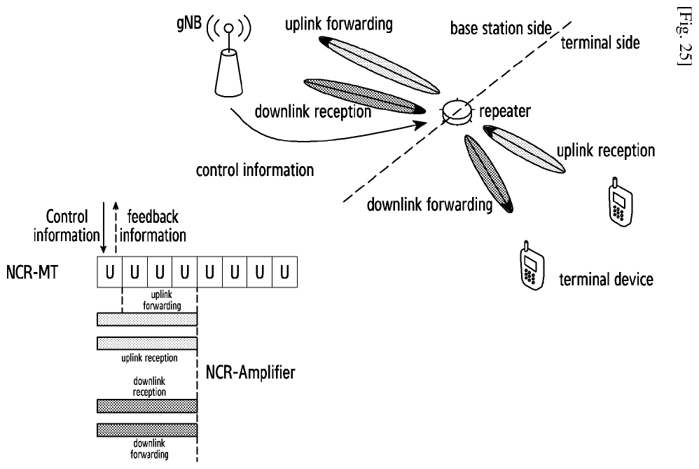

FIG. 28 illustrates an example of a repeater not transmitting and/or not receiving signal according to an embodiment of the present disclosure. FIG. 28 is similar to Example 8 of Embodiment 1, except that the uplink reception and/or uplink forwarding timing of the NCR-Amplifier is determined according to the uplink grid of the NCR-MT. That is, take the uplink grid of the NCR-MT as reference, the NCR-Amplifier does not perform uplink forwarding and/or uplink reception (or downlink forwarding and/or downlink reception) on the time resources (symbols) reserved for (occupied by) the NCR-MT and the switching time resources related to the time resources reserved for the NCR-MT.

In addition, it should be noted that in the above example, it can be understood that the corresponding time unit in which the NCR-Amplifier does not perform downlink reception, downlink forwarding, uplink reception and/or uplink forwarding is a symbol. Wherein, the subcarrier spacing corresponding to the symbol is the reference subcarrier spacing (provided by referenceSubcarrierSpacing in tdd-UL-DL-ConfigurationCommon). In addition, take T_{diff}=T_{TA} as an example in this example.

The NCR-MT of the repeater determines the time domain resources for the NCR-MT and NCR-Amplifier switching (for example, the unit is an uplink symbol, considering TA); the NCR-Amplifier of the repeater does not perform (stop) downlink reception and/or not perform (stop) downlink forwarding (and/or, does not perform (stop) uplink reception and/or does not perform (stop) uplink forwarding) in the NCR-Amplifier symbols overlapping with the time domain resources.

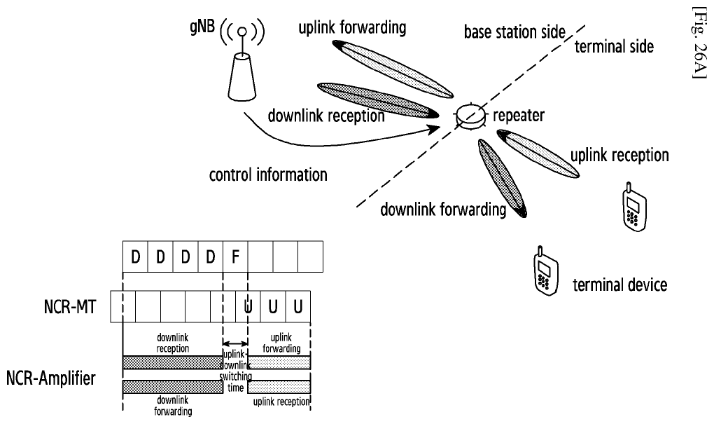

FIG. 29 illustrates a flowchart of a method performed by a repeater according to an embodiment of the present disclosure.

As shown in FIG. 29, in step 2910, control information is received from a base station. In step 2920, based on the control information, first time domain resources are determined. In step 2930, signal is transmitted and/or received on the first time domain resources.

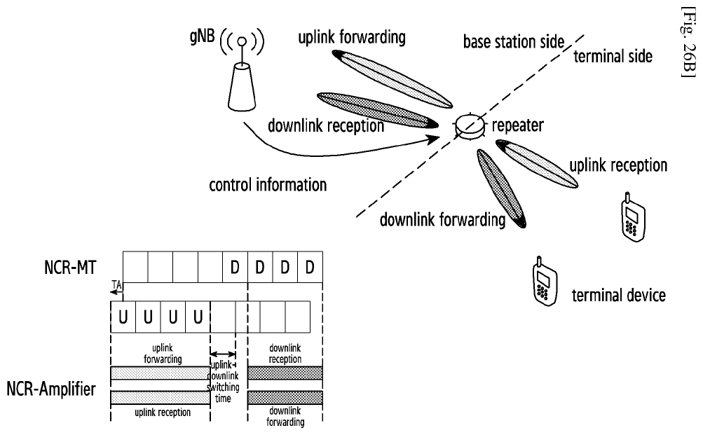

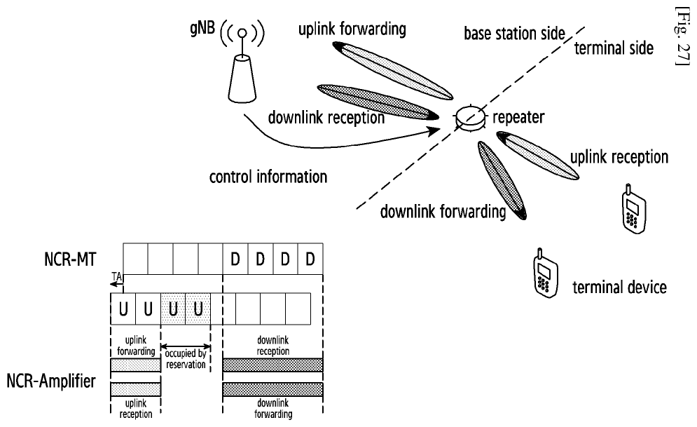

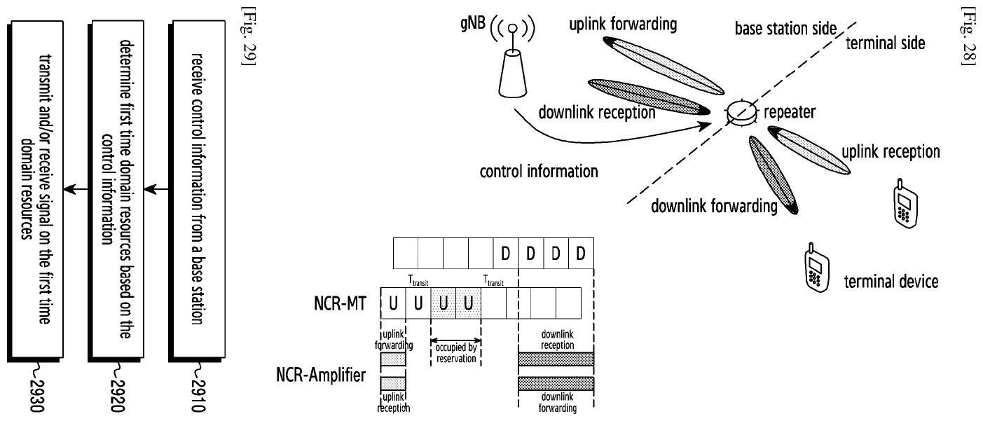

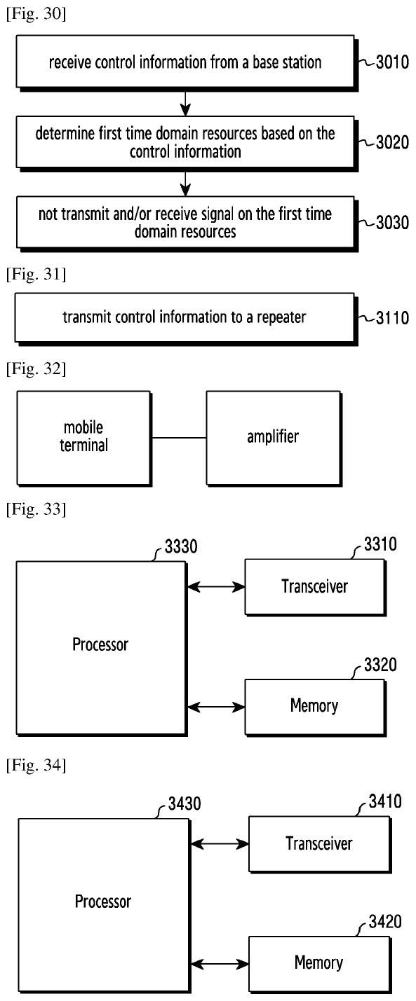

FIG. 30 illustrates a flowchart of a method performed by a repeater according to an embodiment of the present disclosure.

As shown in FIG. 30, in step 3010, control information is received from a base station. In step 3020, based on the control information, first time domain resources are determined. In step 3030, signal is not transmitted and/or received on the first time domain resources.

FIG. 31 illustrates a flowchart of a method performed by a base station according to an embodiment of the present disclosure. As shown in FIG. 31, in step 3110, control information is transmitted to the repeater, where the control information is used to determine first time domain resources and the first time domain resources are used to transmit and/or receive signal. after step 3110, the repeater determine first time domain resources based on the control information received from the base station. after this, signal is transmitted and/or received on the first time domain resources.

FIG. 32 illustrates a block diagram of a repeater according to an embodiment of the present disclosure.

As shown in FIG. 32, a repeater according to an embodiment of the present disclosure includes a mobile terminal and an amplifier, wherein the mobile terminal and the amplifier are respectively configured to perform the above-described method according to the embodiment of the present disclosure.

FIG. 33 illustrates a block diagram of a base station according to an embodiment of the present disclosure. FIG. 33 corresponds to the example of the gNB of FIG. 3B.

As shown in FIG. 33, the base station according to an embodiment may include a transceiver 3310, a memory 3320, and a processor 3330. The transceiver 3310, the memory 3320, and the processor 3330 of the base station may operate according to a communication method of the base station described above. However, the components of the base station are not limited thereto. For example, the base station may include more or fewer components than those described above. In addition, the processor 3330, the transceiver 3310, and the memory 3320 may be implemented as a single chip. Also, the processor 3330 may include at least one processor.

The transceiver 3310 collectively refers to a base station receiver and a base station transmitter, and may transmit/receive a signal to/from a terminal or a network entity. The signal transmitted or received to or from the terminal or a network entity may include control information and data. The transceiver 3310 may include a RF transmitter for up-converting and amplifying a frequency of a transmitted signal, and a RF receiver for amplifying low-noise and down-converting a frequency of a received signal. However, this is only an example of the transceiver 3310 and components of the transceiver 3310 are not limited to the RF transmitter and the RF receiver.

Also, the transceiver 3310 may receive and output, to the processor 3330, a signal through a wireless channel, and transmit a signal output from the processor 3330 through the wireless channel.

The memory 3320 may store a program and data required for operations of the base station. Also, the memory 3320 may store control information or data included in a signal obtained by the base station. The memory 3320 may be a storage medium, such as read-only memory (ROM), random access memory (RAM), a hard disk, a CD-ROM, and a DVD, or a combination of storage media.

The processor 3330 may control a series of processes such that the base station operates as described above. For example, the transceiver 3310 may receive a data signal including a control signal transmitted by the terminal, and the processor 3330 may determine a result of receiving the control signal and the data signal transmitted by the terminal.

FIG. 34 illustrates a block diagram of a terminal (or a user equipment (UE)), according to embodiments of the present disclosure. FIG. 34 corresponds to the example of the UE of FIG. 3A.

As shown in FIG. 34, the UE according to an embodiment may include a transceiver 3410, a memory 3420, and a processor 3430. The transceiver 3410, the memory 3420, and the processor 3430 of the UE may operate according to a communication method of the UE described above. However, the components of the UE are not limited thereto. For example, the UE may include more or fewer components than those described above. In addition, the processor 3430, the transceiver 3410, and the memory 3420 may be implemented as a single chip. Also, the processor 3430 may include at least one processor.

The transceiver 3410 collectively refers to a UE receiver and a UE transmitter, and may transmit/receive a signal to/from a base station or a network entity. The signal transmitted or received to or from the base station or a network entity may include control information and data. The transceiver 3410 may include a RF transmitter for up-converting and amplifying a frequency of a transmitted signal, and a RF receiver for amplifying low-noise and down-converting a frequency of a received signal. However, this is only an example of the transceiver 3410 and components of the transceiver 3410 are not limited to the RF transmitter and the RF receiver.

Also, the transceiver 3410 may receive and output, to the processor 3430, a signal through a wireless channel, and transmit a signal output from the processor 3430 through the wireless channel.

The memory 3420 may store a program and data required for operations of the UE. Also, the memory 3420 may store control information or data included in a signal obtained by the UE. The memory 3420 may be a storage medium, such as read-only memory (ROM), random access memory (RAM), a hard disk, a CD-ROM, and a DVD, or a combination of storage media.

The processor 3430 may control a series of processes such that the UE operates as described above. For example, the transceiver 3410 may receive a data signal including a control signal transmitted by the base station or the network entity, and the processor 3430 may determine a result of receiving the control signal and the data signal transmitted by the base station or the network entity.

It should be understood that various time and/or time quantities used in this disclosure can be an absolute time, such as millisecond, microsecond, sample point (Tc), a slot, a symbol. It can also be understood that the repeater according to the embodiment of the present disclosure can perform various operations and methods disclosed herein in the time unit corresponding to the reference grid overlapping with the time domain resources of the time and/or time quantities described herein. It can also be understood that the repeater according to the embodiment of the present disclosure can perform various operations and methods disclosed herein in the first (relative) time unit after the time unit corresponding to the reference grid overlapped with the time domain resources of absolute time and/or absolute time quantities described herein. The time quantities used in this disclosure are only used as examples to describe the specific embodiments of this disclosure and should not be regarded as a limitation on the specific embodiments of this disclosure.

The illustrative logical blocks, modules, and circuits described in this disclosure can be implemented with a general purpose processor, a Digital Signal Processor (DSP), an application specific integrated circuit (ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, micro-controller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure can be embodied directly in hardware, in a software module performed by a processor, or in a combination of the both. The software modules may reside in a RAM memory, a flash memory, a ROM memory, an EPROM memory, an EEPROM memory, registers, hard disks, removable disks, or any other form of storage media known in the art. An exemplary storage medium is coupled to the processor so that the processor can read and write information from/to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

In one or more exemplary designs, the functions can be implemented in hardware, software, firmware, or any combination thereof. If implemented in software, each function can be stored on or transmitted by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

With reference to the drawings, the description set forth herein describes example configurations, methods and devices, and does not represent all examples that can be implemented or within the scope of the claims. As used herein, the term “example” means “serving as an example, instance or illustration”, not “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains a number of specific implementation details, these should not be construed as limitations on any invention or the scope of the claimed protection, but descriptions of specific features of specific embodiments of specific inventions. Some features described in this specification in the context of individual embodiments can also be combined in a single embodiment. On the contrary, various features described in the context of a single embodiment can also be implemented in multiple embodiments alone or in any suitable sub-combination. Furthermore, although features can be described above as functioning in some combinations, and even initially claimed as such, in some cases, one or more features from the claimed combination can be deleted from the combination, and the claimed combination can be aimed at sub-combinations or variants of sub-combinations.

It should be understood that the specific order or hierarchy of steps in the method of the present invention is an illustration of an exemplary process. Based on the design preference, it can be understood that the specific order or hierarchy of steps in the method can be rearranged to achieve the disclosed functions and effects of the present invention. The attached method claims present elements of various steps in an example order, and are not meant to be limited to the specific order or hierarchy presented, unless otherwise stated. In addition, although the elements can be described or claimed in the singular form, the plural is also contemplated unless the limitation of the singular is explicitly stated. Therefore, the present disclosure is not limited to the illustrated examples, and any device for performing the functions described herein is included in various aspects of the present disclosure.

And the text and drawings are only provided as examples to help readers understand this disclosure. They are not intended and should not be construed to limit the scope of the present disclosure in any way. Although some embodiments and examples have been provided, based on the disclosure herein, it is obvious to those skilled in the art that changes can be made to the illustrated embodiments and examples without departing from the scope of this disclosure.

1. A method performed by a network controlled repeater (NCR) comprising an NCR mobile terminal (NCR-MT) and an NCR forward (NCR-FWD) in a wireless communication system, the method comprising:
receiving, from a user equipment (UE), a first uplink signal; and
identifying a time resource for transmitting a second uplink signal for forwarding the first uplink signal to a base station (BS),
wherein the NCR does not support simultaneous transmissions of the second uplink signal and a third uplink signal to the BS.

2. The method of claim 1, wherein, in case that the third uplink signal on the time resource is being transmitted, a transmission of the second uplink signal on the time resource is not performed.

3. The method of claim 1, wherein an uplink transmission timing of the second uplink signal is identified according to a frame timing for an uplink transmission timing of the third uplink signal.

4. The method of claim 1, wherein time division duplex (TDD) uplink-downlink configuration information is received from the BS, and
wherein the time resource is identified based on the TDD uplink-downlink configuration information.

5. The method of claim 4, wherein the TDD uplink-downlink configuration information includes a slot format indicating at least one uplink symbol for the time resource.

6. The method claim 4, wherein the TDD uplink-downlink configuration information includes a cell-specific TDD configuration or an NCR-specific TDD configuration.

7. The method of claim 1, wherein the NCR-FWD amplifies and forwards the first uplink signal to the BS.

8. The method of claim 1, wherein side control information is received by the NCR-MT from the BS, and wherein the NCR-FWD is controlled based on the side control information.

9. A network controlled repeater (NCR) comprising an NCR mobile terminal (NCR-MT) and an NCR forward (NCR-FWD) in a wireless communication system, the NCR comprising:
a transceiver; and
a controller coupled with the transceiver and configured to:
receive, from a user equipment, UE, a first uplink signal, and
identify a time resource for transmitting a second uplink signal for forwarding the first uplink signal to a base station (BS),
wherein the NCR does not support simultaneous transmissions of the second uplink signal and a third uplink signal to the BS.

10. The NCR of claim 9, wherein, in case that the third uplink signal on the time resource is being transmitted, a transmission of the second uplink signal on the time resource is not performed.

11. The NCR of claim 9, wherein an uplink transmission timing of the second uplink signal is identified according to a frame timing for an uplink transmission timing of the third uplink signal.

12. The NCR of claim 9, wherein time division duplex (TDD) uplink-downlink configuration information is received from the BS, and
wherein the time resource is identified based on the TDD uplink-downlink configuration information.

13. The NCR of claim 12, wherein the TDD uplink-downlink configuration information includes a slot format indicating at least one uplink symbol for the time resource.

14. The NCR of claim 13, wherein the TDD uplink-downlink configuration information includes a cell-specific TDD configuration or an NCR-specific TDD configuration.

15. The NCR of claim 9, wherein the NCR-FWD amplifies and forwards the first uplink signal to the BS,
wherein the second uplink signal is associated with the NCR-FWD, and
wherein the third uplink signal is associated with the NCR-MT.

16. The method of claim 1, wherein the second uplink signal is associated with the NCR-FWD, and wherein the third uplink signal is associated with the NCR-MT.

17. The NCR of claim 9, wherein side control information is received by the NCR-MT from the BS, and wherein the NCR-FWD is controlled based on the side control information.

18. The NCR of claim 9, wherein the second uplink signal is associated with the NCR-FWD, and wherein the third uplink signal is associated with the NCR-MT.
